(19) United States
(12) Patent Application Publication
(10) Pub. No.: US 2026/0121726 A1
(43) Pub. Date: Apr. 30, 2026

(54) Transition of Radio Access Service Between Mobile Radio Access Points

(71) Applicant: HUAWEI TECHNOLOGIES CO., LTD., SHENZHEN (CN)

(72) Inventor: William Anthony GAGE, Kanata (CA)

(73) Assignee: HUAWEI TECHNOLOGIES CO., LTD., SHENZHEN (CN)

(21) Appl. No.: 18/926,407

(22) Filed: Oct. 25, 2024

Related U.S. Application Data
(63) Continuation of application No. PCT/CN2022/089465, filed on Apr. 27, 2022.

(51) Int. Cl. H04B 7/06; H04W 52/36; H04W 76/20

(52) U.S. Cl. CPC H04B 7/0691; H04W 52/367; H04W 76/20

(57) ABSTRACT

Methods and apparatus for providing a radio access service to wireless end-user devices from a group of mobile radio access points, mobile radio access points such as unmanned, low-altitude aerial devices are provided. Information exchanged between a wireless end-user device and a terrestrial base station may be relayed through one or more mobile radio access points. As mobile radio access points travel along their paths, the association between a wireless end-user device and serving radio access point may change. Radio access points coordinate their operations to ensure that the radio access service to a particular wireless end-user device transitions from an old serving to a new serving radio access point in a manner that is relatively transparent to the operation of the wireless end-user device and utilizes their inherent beam switching behaviours.

### CROSS-REFERENCE TO RELATED APPLICATION

This application is a continuation of International Application No. PCT/CN2022/089465, filed on Apr. 27, 2022, the disclosure of which is hereby incorporated by reference in its entirety.

### TECHNICAL FIELD

The present invention pertains in general to the field of wireless communication networks, and in particular to methods and systems for providing radio access to a wireless communication service using mobile radio access points.

### BACKGROUND

Wireless communication networks such as so-called fifth generation (5G) broadband networks, and beyond, are well established for providing communication services to a variety of wireless devices. In a typical architecture, a wireless device within a particular area accesses a communication service by using a two-way wireless communication channel that is associated with a nearby radio access point. In recent implementations and proposals, the wireless communication channel can involve the use of millimeter wave radio frequency bands, for example above 24 GHz.

Particularly at such high frequencies, radio access points may need to be located relatively close to wireless devices, and line-of-sight or near-line-of-sight communications may be preferred. Furthermore, the service demands on the network at a particular location may vary significantly over time, for example as users with wireless devices temporarily congregate within a region or demand for wireless communication services varies. In order to economically accommodate such variation, or for other reasons such as network flexibility, mobile radio access points may be deployed. In some cases these mobile radio access points can be moved to different locations at different times in response to service demand. In other cases, for example when the mobile radio access points are satellite-based, mobile radio access points can still be used to serve different regions opportunistically.

Using conventional handover protocols, such as those defined by the 3^{rd} Generation Partnership Project (3GPP™), significant communication overhead is incurred each time access to a communication service by a wireless device is transferred to a different radio access point. This may occur for example when a mobile radio access point moves out of range of a wireless device. This overhead can result in spectral inefficiency as well as an undesirable amount of power usage at power-limited wireless devices and mobile radio access points.

Therefore, there is a need for an improved procedure for associating a wireless device with a different mobile radio access point that obviates or mitigates one or more deficiencies of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide methods and systems for associating wireless devices with mobile radio access points, transitioning radio access services between mobile radio access points, or a combination thereof.

Embodiments of the disclosure describe mechanisms used by a group of mobile radio access points for providing access to a communication service to wireless (e.g. end-user) devices via a radio frequency (RF) channel (i.e. radio access). The mobile radio access points may, for example, be incorporated into unmanned (or uncrewed) aerial vehicles, mass transit (e.g. bus, train) systems and vehicular (e.g. car, truck, taxi) platforms. Information exchanged between a wireless device and a conventional stationary (i.e. non-mobile) base station may be relayed through one or more of these mobile radio access points. As mobile radio access points travel through the service area, the association between a wireless device and a serving mobile radio access point may change. According to various embodiments, the mobile radio access points coordinate their operations to facilitate the transition of radio access service to a particular wireless device from an old serving to a new serving access point in an expedient manner. In particular, the transition of radio access service may be substantially or relatively transparent to the operation of the wireless device. Such transparency may refer to the wireless device operating without needing to adapt to the presence and use of the embodiments as disclosed herein.

In various embodiments, mobile radio access points perform actions which trigger existing beam switching operations of the wireless devices. Such a beam switching operation may involve a set of wireless devices ceasing to use a radio access service (to access a wireless communication service) associated with a cell via a wireless communication beam associated with a mobile radio access point and beginning to use the radio access service associated with the cell via another wireless communication beam associated with another radio access point. Accordingly, a “transition” type of operation can be performed when one mobile radio access point is moving out of range of a certain coverage area and another mobile radio access point is moving into range of the coverage area. Because the beam switching operations of the wireless devices are pre-existing behaviours, legacy wireless devices can be made to switch from one radio access point to another radio access point without further configuration. Furthermore, such beam switching operation, along with the cooperation of multiple radio access points to function together as a single cell from a wireless device or network perspective, allows the transition of radio access service between mobile radio access points to be performed with relatively low signalling overhead.

In accordance with an embodiment of the present disclosure, there is provided a radio access point having a processor and a wireless communication interface, the radio access point being mobile and configured to transmit, to a set of wireless devices in a coverage area, an indication that the radio access point is providing a radio access service associated with a cell in a wireless service area, the coverage area being a sub-region of the wireless service area, and the indication comprising a cell identifier corresponding to the cell in the wireless service area and a first beam identifier corresponding to a first wireless communication beam between the radio access point and the set of wireless devices in the coverage area, the first beam identifier being selected from a set of beam identifiers associated with the cell identifier. The radio access point is further configured to subsequently cooperate with a second radio access point to determine that the radio access point is to relinquish to the second radio access point providing, to the set of wireless devices in the coverage area, the radio access service associated with the cell. The radio access point is further configured to subsequently, and further in response to an indication that the second radio access point has begun providing, to the set of wireless devices in the coverage area, the radio access service associated with the cell, taking one or more actions which contribute to causing the set of wireless devices in the coverage area to perform a beam switching operation, the beam switching operation comprising the set of wireless devices ceasing to utilise the first wireless communication beam for the radio access service associated with the cell and beginning to utilise a second wireless communication beam associated with the second radio access point for the radio access service associated with the cell, the second wireless communication beam associated with a second beam identifier selected from the set of beam identifiers associated with the cell.

Said one or more actions taken by the radio access point which contribute to causing the set of wireless devices in the coverage area to perform a beam switching operation, may include inhibiting transmission to the set of wireless devices in the coverage area of at least one of the cell identifier and the first beam identifier. Said one or more actions may include reducing a strength of communication signals to the set of wireless devices by one or a combination of: motion of the radio access point away from the coverage area; directing of the first wireless communication beam away from the coverage area; and decreasing of a transmission power associated with the first wireless communication beam.

The cell identifier and the first beam identifier may be conveyed in a synchronization signal block (SSB), the cell identifier comprising a physical cell identifier (PCI) associated with the cell in the wireless service area and the first beam identifier comprising a time domain transmission interval associated with the PCI.

The coverage area may be associated with a coverage area identifier and the radio access point may be further configured, while providing the radio access service to the set of wireless devices in the coverage area, to: receive a downlink information in a protocol data unit associated with the coverage area identifier; extract the downlink information from the protocol data unit; and transmit the downlink information via the first wireless communication beam associated with the coverage area.

Wherein the coverage area is associated with a coverage area identifier, the radio access point may be further configured, while providing the radio access service to the set of wireless devices in the coverage area, to: receive, via the first wireless communication beam associated with the coverage area, an uplink information from a wireless device in the set of wireless devices; encapsulate the uplink information in a protocol data unit associated with the coverage area identifier; and transmit the uplink information in the protocol data unit associated with the coverage area identifier.

Said cooperating by the radio access point with the second radio access point may further comprise: the radio access point receiving a first message from the second radio access point, the first message indicating that the second radio access point is able to provide the radio access service to the coverage area; and transmitting, to the second radio access point, a second message indicative that the radio access point will relinquish providing of the radio access service to the coverage area. The second message may be indicative of one or both of: the cell identifier; and the set of beam identifiers associated with the cell identifier. The second message may be indicative of the set of wireless devices in the coverage area and a radio resource configuration associated with each wireless device in the set of wireless devices in a coverage area.

The indication that the second radio access point has begun providing, to the set of wireless devices in the coverage area, the radio access service associated with the cell, may indicate that the second radio access point is transmitting, to the set of wireless devices in the coverage area, the cell identifier and the second beam identifier. The indication may further comprise a message from the second radio access point, the message indicative that the second mobile radio access point is transmitting the cell identifier and the second beam identifier to the set of wireless devices in the coverage area.

The cell identifier corresponding to the cell in the wireless service area may be selected according to one of: pre-configuration; derivation based on an attribute of the coverage area; selection from a pre-configured set of candidate cell identifiers; and selection from a set of candidate cell identifiers determined to be available for use within the coverage area.

In accordance with an embodiment of the present disclosure, there is provided a system comprising a first radio access point, the first radio access point being mobile and configured to transmit, to a set of wireless devices in a coverage area, an indication that the first radio access point is providing a radio access service associated with a cell in a wireless service area, the coverage area being a sub-region of the wireless service area, the indication comprising a cell identifier corresponding to the cell in the wireless service area and a first beam identifier corresponding to a first wireless communication beam between the first radio access point and the set of wireless devices in the coverage area, the first beam identifier being selected from a set of beam identifiers associated with the cell identifier. The first radio access point is further configured to subsequently cooperate with a second radio access point to determine that the first radio access point is to relinquish to the second radio access point providing, to the set of wireless devices in the coverage area, the radio access service associated with the cell. The first radio access point is further configured to subsequently, and further in response to an indication that the second radio access point has begun providing, to the set of wireless devices in the coverage area, the radio access service associated with the cell, taking one or more actions which contribute to causing the set of wireless devices in the coverage area to perform a beam switching operation. The second radio access point is configured to determine that the first radio access point is providing, to the set of wireless devices in the coverage area, the radio access service associated with the cell. The second radio access point is further configured to subsequently cooperate with the first radio access point to determine that the first radio access point will relinquish to the second radio access point said providing, to the set of wireless devices in the coverage area, the radio access service associated with the cell. The second radio access point is further configured to select a second beam identifier from the set of beam identifiers associated with the cell identifier, the second beam identifier different from the first beam identifier, wherein the second beam identifier corresponds to a second wireless communication beam between the second radio access point and the set of wireless devices in the coverage area. The second radio access point is further configured to transmit, to the set of wireless devices in the coverage area, an indication that the second radio access point is providing the radio access service associated with the cell in the wireless service area, the indication comprising the cell identifier corresponding to the cell in the wireless service area and the second beam identifier. The second radio access point is further configured to transmit, to the first radio access point, an indication that the second radio access point has begun providing, to the set of wireless devices in the coverage area, the radio access service associated with the cell. The system may further comprise a plurality of radio access points including the first radio access point and the second radio access point, wherein the plurality of radio access points are cooperatively configured to operate as the cell associated with the cell identifier from a perspective of the set of wireless devices, each radio access point in the plurality of radio access points associated with at least one distinct beam identifier selected from the set of beam identifiers associated with the cell identifier. The system may further include a wireless device in the set of wireless devices configured to perform the beam switching operation, the beam switching operation comprising accessing the radio access service associated with the cell via the first wireless communication beam; and upon determining that the radio access service associated with the cell cannot be adequately provided via the first wireless communication beam, accessing the radio access service associated with the cell via the second wireless communication beam.

In accordance with an embodiment of the present disclosure, there is provided a radio access point having a processor and a wireless communication interface, the radio access point being mobile and configured to: determine that the radio access point is to assume, from a second radio access point, providing of a radio access service to a set of wireless devices in a coverage area, the coverage area being a sub-region of a wireless service area, the radio access service being associated with a cell identifier corresponding to a cell in the wireless service area and provided by the second radio access point via a first wireless communication beam associated with the second radio access point, the first wireless communication beam associated with the cell in the wireless service area and a first beam identifier selected from a set of beam identifiers associated with the cell identifier. The radio access point is further configured to transmit, to the set of wireless devices in the coverage area, an indication that the radio access point is providing the radio access service associated with the cell, the indication comprising the cell identifier associated with the cell and a second beam identifier corresponding to a second wireless communication beam between the radio access point and the set of wireless devices in the coverage area, the second beam identifier being selected from the set of beam identifiers associated with the cell identifier and being different from the first beam identifier associated with the second radio access point. The radio access point is further configured to subsequently indicate, to the second radio access point, that the radio access point has begun providing the radio access service associated with the cell to the set of wireless devices in the coverage area. Subsequently to said indicating to the second radio access point, the set of wireless devices in the coverage area may perform a beam switching operation comprising ceasing to utilise the first wireless communication beam for the radio access service associated with the cell and beginning to utilise the second wireless communication beam associated with the radio access point for the radio access service associated with the cell. The cell identifier and the second beam identifier may be conveyed in a synchronization signal block (SSB), the cell identifier comprising a physical cell identifier (PCI) associated with the cell in the wireless service area and the second beam identifier comprising a time domain transmission interval associated with the PCI.

The indication that the radio access point has begun providing the radio access service may include an indication that the radio access point is transmitting, to the set of wireless devices in the coverage area, the cell identifier and the second beam identifier. The indication may further comprise transmitting a message from the radio access point to the second radio access point, the message indicative that the radio access point is transmitting the cell identifier and the second beam identifier to the set of wireless devices in the coverage area.

The coverage area may be associated with a coverage area identifier and the radio access point may be further configured, while providing the radio access service to the set of wireless devices in the coverage area, to: receive a downlink information in a protocol data unit associated with the coverage area identifier; extract the downlink information from the protocol data unit; and transmit the downlink information via the second wireless communication beam.

The coverage area may be associated with a coverage area identifier and the radio access point may be further configured, while providing the radio access service to the set of wireless devices in the coverage area, to: receive, via the second wireless communication beam, an uplink information from a wireless device in the set of wireless devices; encapsulate the uplink information in a protocol data unit associated with the coverage area identifier; and transmit, to a network device, the uplink information in the protocol data unit associated with the coverage area identifier.

According to embodiments of the present disclosure, there are provided systems and methods and associated computer program products. The computer program products include a computer-readable medium having recorded statements and instructions which, when executed by a computer or a set of computers, cause the computer or set of computers to carry out a corresponding method. The methods may be executed by a device or a set of devices, where the devices may include radio access points, mobile radio access points, wireless devices, stationary base stations, or combinations thereof. The devices may execute the methods by virtue of computers (e.g. microprocessors) executing program instructions, or by virtue of electronics (e.g. integrated circuits) or other components configured to implement the operations described. The methods include operations commensurate with the operations of radio access points, mobile radio access points, wireless devices, stationary base stations, or systems, as already described above.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates a radio access network (RAN) connections and interfaces within a 3GPP™ fifth generation (5G) network system.

FIG. 2 illustrates the transition of a radio access service from one low-altitude mobile radio access point (LAMP) to another LAMP in an integrated terrestrial and aerial radio access network, according to embodiments of the present disclosure.

FIG. 3 illustrates the components of an integrated terrestrial and aerial radio access network, according to embodiments of the present disclosure.

FIG. 4 illustrates different potential beam configurations for mobile radio access points, according to embodiments of the present disclosure.

FIG. 5 illustrates transition of coverage area radio access service from one mobile radio access point to another mobile radio access point, according to embodiments of the present disclosure.

FIGS. 6A and 6B illustrate an example procedure with a series of steps for a transition of radio access service for a coverage area, according to embodiments of the present disclosure.

FIG. 7 illustrates an Nu reference point protocol data unit (PDU) which may be used to exchange information across a logical neighbour link between neighbouring mobile radio access points or between a mobile radio access point and a host terrestrial base station, according to embodiments of the present disclosure.

FIG. 8 illustrates an Nu Neighbour Advertisement PDU, according to embodiments of the present disclosure.

FIG. 9 illustrates an Nu Coverage Area Probe PDU, according to embodiments of the present disclosure.

FIG. 10 illustrates an Nu Coverage Area Probe response PDU, according to embodiments of the present disclosure.

FIG. 11 illustrates an Nu Coverage Area Cell Context Transfer PDU, according to embodiments of the present disclosure.

FIG. 12 illustrates an Nu Coverage Area Device Context Transfer PDU, according to embodiments of the present disclosure.

FIG. 13 illustrates an Nu Coverage Area Transition Complete PDU, according to embodiments of the present disclosure.

FIG. 14A illustrates an Nu Downlink Data Transfer PDU, according to embodiments of the present disclosure.

FIG. 14B illustrates an Nu Uplink Data Transfer PDU, according to embodiments of the present disclosure.

FIG. 15 illustrates a schematic diagram of an electronic device, according to different embodiments of the present invention.

It will be noted that throughout the appended drawings, like features are identified by like reference numerals.

### DETAILED DESCRIPTION

Embodiments of the present disclosure relate to mechanisms for providing radio access service to wireless end-user devices from a covey (or small group) of mobile radio access points, such as but not necessarily limited to aerial unmanned, low-altitude, mobile radio access points. For a wireless end-user device (WD), a mobile radio access point such as an aerial low-altitude mobile radio access point (LAMP) embodies a cell of a radio access network (RAN) that is providing wireless services to the WD. Conceptually, a mobile radio access point may operate like a RAN node distributed unit (DU) that relays information between a WD and a RAN node centralised unit (CU) that is located in a remote conventional stationary terrestrial base station (TBS) (i.e. a base station that is not aerial and is not mobile). A radio access service is understood to be a service, e.g. provided by radio access points, which allows wireless devices to connect with a broader wireless communication service. The wireless communication service may facilitate communication between different wireless devices, or between a wireless device and other networked devices, or other telecommunications infrastructure. A device providing a radio access service may thus also inherently provide or facilitate providing a wireless communication service.

Although, for clarity, embodiments of the present disclosure are described primarily with respect to aerial mobile radio access points such as LAMPs, it should be understood that the radio access points may be aerial mobile radio access points; terrestrial mobile radio access points; low earth orbit satellite mobile radio access points; terrestrial stationary radio access points; aerial stationary radio access points; geo-stationary satellite radio access points; or a combination thereof. For example, terrestrial mobile radio access points may include those deployed in mass transit (e.g. bus, train) systems and vehicular (e.g. car, truck, taxi) platforms.

Before proceeding with a detailed description of the embodiments and solutions of the present disclosure, a review of some current state-of-the-art wireless communication system functions and architectures is provided. This review is provided in order to contextualize embodiments of the present disclosure. For example, the review presents certain requirements and behaviours of existing wireless devices and other system components. In view of this, contributions of the present disclosure can be more readily discerned. For example, in view of beam switching operations of existing wireless devices, it can be more readily appreciated how embodiments of the present disclosure leverage existing wireless device behaviour, to associate wireless devices with new mobile radio access points.

### 3GPP™ Ran Reference Architecture

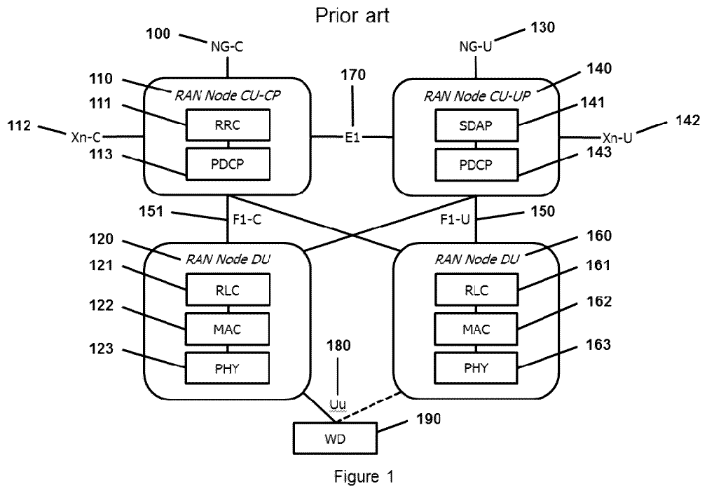

As illustrated in FIG. 1, a radio access network (RAN) node in a 5G system in accordance with the 3GPP™ Specification TS 38.401, “NG-RAN; Architecture description” version 16.8.0, December 2021, may be connected to a core network (CN) control plane entity through an interface known as NG-C 100 (Next Generation Control Plane Interface) (or N2) and to a CN user plane entity through an interface known as NG-U 130 (Next Generation User Plane Interface) (or N3). The CN control plane entity is also connected to user equipment (UE) through an interface known as N1 (not shown). The N1 control plane messages are transparently conveyed through the RAN node as non-access stratum (NAS) signalling.

A RAN node may be connected to a UE such as a wireless end-user device 190 (WD) via a New Radio (NR) radio link interface 180 (known as Uu) that comprises several entities associated with a radio link protocol stack: a physical layer (PHY) entity 123, 163; a medium access control (MAC) entity 122, 162; a radio link control (RLC) entity 121, 161; a packet data convergence protocol (PDCP) entity 113, 143; a service data adaptation protocol (SDAP) entity 141; and a radio resource control (RRC) entity 111.

A RAN node may be connected to other RAN nodes via an interface known as Xn that includes both a control plane component (Xn-C 112) and a user plane component (Xn-U 142). In a 3GPP™ Long Term Evolution (LTE) system, similar interfaces may exist: a RAN node may be connected to a CN through an interface known as S1 and to other RAN nodes through an interface known as X2 (not shown).

A RAN node may be decomposed into a set of network elements that can be distributed to different locations within the RAN. For example, as illustrated in FIG. 1, a RAN distributed unit 120, 160 (DU) may be located close to a radio transmission and reception unit for direct communications with a WD 190. A RAN centralised unit (CU) may be located in a data centre with communications between a RAN DU and CU conveyed over an interface known as F1 151, 150. The RAN CU may be decomposed further into a RAN CU control plane entity (CU-CP 110) and one or more RAN CU user plane entities (CU-UP 140) with communications between a CU-CP 110 and CU-UP 140 conveyed over an interface known as E1 170.

Typically, a RAN DU 120, 160 houses the lower layer entities of the radio link protocol stack (PHY 123, 163; MAC 122, 162; and RLC 121, 161 entities) while a RAN CU 110, 140 houses the upper layer entities of the radio link protocol stack (PDCP 113 and RRC 111 entities in the CU-CP 110; PDCP 143 and SDAP 141 entities in the CU-UP 140).

### 3GPP™ Radio Link Beam Management

A WD in a 5G system uses discovery of a synchronisation signal block (SSB) broadcast by a RAN node to identify a potential serving cell in accordance with the 3GPP™ Specification TS 38.300, “NR and NG-RAN Overall Description; Stage 2” version 16.8.0, December 2021. An SSB consists of a primary synchronisation signal (PSS), a secondary synchronisation signal (SSS), and a physical broadcast channel (PBCH). The PSS and SSS together encode a physical cell identifier (PCI) that can be used by a WD to distinguish downlink transmissions from neighbouring cells; up to 1008 unique PCIs can be encoded by the PSS and SSS in a 5G system. In accordance with the 3GPP™ Specification TS 38.212, “NR; Multiplexing and Channel Coding” version 17.0.0, December 2021, the PBCH contains the minimum system information (MSI) needed by a WD to access the network and also includes timing information needed by a WD to determine frame alignment and to identify transmission beams.

Beam forming may be used to mitigate path loss at higher frequencies such as those in millimetre-wave spectrum. In order to align a downlink beam (used for transmissions from a cell) to a corresponding receiver beam (used for reception at a WD), a cell periodically broadcasts synchronisation information in a time-multiplexed way such that one SSB, associated with one beam, is transmitted in each time slot. A sequence of the time-multiplexed transmissions is known as an SSB burst set. Every SSB in the SSB burst set encodes the same PCI (i.e. the same PSS and SSS) and conveys the same MSI in its PBCH. To identify the SSB (beam) within a burst set, each SSB in the burst set includes a different time index, transmitted in the PBCH of the SSB.

An SSB may not be transmitted in all possible time slots of the SSB burst set. There may be between one and a predefined maximum number of SSB transmissions within an SSB burst set, depending on the number of beams associated with the serving cell. If less than the maximum number of SSBs is transmitted, then the transmitted SSBs do not have to be transmitted in consecutive SSB burst set time slots. Any subset of the possible set of time slots can be used for the SSB transmission. The SSBs actually transmitted in an SSB burst set are indicated by a bit map broadcast by the serving cell in a system information block (SIB) in accordance with the 3GPP™ Specification TS 38.331, “NR; Radio Resource Control (RRC) protocol specification” version 16.7.0, December 2021.

### Non-Terrestrial Radio Access

In some wireless communications systems, non-terrestrial radio access platforms (such as those illustrated in the 3GPP™ Technical Report TR 38.821, “Solutions for NR to support non-terrestrial networks (NTN)” version 16.1.0, June 2021) may be used to enhance radio coverage in a RAN. Non-terrestrial platforms are typically categorised according to their average height above the terrain (e.g. Geostationary Orbit (GEO), Low-Earth Orbit (LEO), and High-Altitude Platform Station (HAPS)).

A low-altitude radio access platform is an unmanned (or uncrewed) aerial vehicle (UAV) that flies at altitudes that may be less than 500 metres above the terrain. Some low-altitude vehicles (e.g. fixed wing) may continuously change their position relative to a terrestrial reference point. Other low-altitude vehicles (e.g. quadcopter) may hover in a fixed position relative to a terrestrial reference point.

Attention is now returned to embodiments and solutions of the present disclosure. The various embodiments of the present disclosure focus on use of low-altitude unmanned aerial vehicles operating as mobile radio access points that provide coverage over an area equivalent to a small cell (i.e. a picocell).

A radio access network (RAN) may employ a low-altitude mobile radio access point (LAMP) to supplement the radio access service coverage provided to a wireless end-user device (WD) by a conventional terrestrial base station (TBS). As a LAMP travels through a service area, the portion of the service area covered by the LAMP changes according to its speed, direction of flight, effective cell diameter, or combinations thereof.

A RAN may employ one or a plurality of LAMPs to supplement the radio access service coverage of the TBS. The LAMP providing radio access service for the WD may change over time according to the combined movement of the WD and the LAMPs. The low altitude of a LAMP and the high frequency of an access link combine to limit the diameter of a cell associated with a LAMP. Consequently, there could be a frequent change in serving LAMP for a WD, possibly resulting in the need for multiple handovers within a short period of time.

Conventionally, an access link handover involves control plane signalling between a WD and its serving RAN node. If the RAN node functions are distributed across a set of network elements (e.g. RAN DU and CU), an access link handover may also require control plane signalling between RAN network elements. Control plane signalling adds latency to the execution of a handover and increases traffic load on radio access links and on network infrastructure links.

Increasing radio transmission power in a LAMP may allow a LAMP to retain an access link connection with a WD for a longer period of time, reducing the frequency of handover. However, increasing radio transmission power in a LAMP may reduce the amount of time that a LAMP can be airborne before it must be re-fuelled, re-charged, or both, resulting in increased operating expenses (OPEX). In addition, increasing access link transmission power in a LAMP may result in increased interference with transmissions by other LAMPs, by WDs, by TBS, or a combination thereof.

Conventionally, the handover of a WD from one cell to another cell is triggered by access link signal quality measurements conducted by the WD and reported to the RAN. Signalling is also required between the WD and the RAN and between various network elements of the RAN in order to coordinate the handover. These signalling procedures must be repeated for every WD transitioning from an old serving to a new serving cell. This results in significant control plane traffic both over the radio link and within the RAN terrestrial network. In addition, replicated sets of radio resources may need to be allocated to the WD in both the old and new cells to ensure a substantially seamless handover.

Radio access service functions incorporated into unmanned (or uncrewed) aerial vehicles offer a cost-effective solution for providing radio access (wireless) coverage in areas of transient network traffic and in hard-to-reach areas. Low-altitude radio access points may be deployed on an as-needed basis to provide interim connectivity between wireless end-user devices and stationary terrestrial base stations. In addition, while active, a low-altitude radio access point may be mobile within a bounded operational zone. A low-altitude mobile radio access point (LAMP) may be configured to operate in millimetre-wave spectrum to take advantage of the larger bandwidth available in that spectrum and to take advantage of the low altitude to mitigate the higher path loss experienced by transmissions in the higher frequencies. In order to maximise its flight duration, a LAMP may operate with low radio transmission power in order to either conserve fuel, or to minimise battery usage, or both. The characteristics of a LAMP may result in a small coverage footprint (cell diameter) that, when combined with the relative velocities of mobile end-user devices, can result in more frequent handovers.

In some embodiments, some or all LAMPs in the covey follow respective flight paths that may be pre-determined. In some embodiments, some or all LAMPs in the covey follow respective flight paths that may be dynamically adjusted according to traffic demand or other criteria.

As a LAMP travels along its flight path, the portion of the TBS service area covered by the LAMP may change according to the speed and direction of LAMP flight. Consequently, in some embodiments, different LAMPs may provide radio access service to a WD at different times even if the WD itself is not mobile.

In some embodiments, as a mobile radio access point moves away from a coverage area where it is currently providing a radio access service to a WD, a reduction in strength of a communication signal between the WD and the mobile radio access point may lead to another radio access point assuming responsibility for providing the radio access service to the WD.

In some embodiments, operations of mobile radio access points in the RAN may be coordinated using a reference to the current location of a WD. In particular, the current location of each WD may be associated with a geographic region known as a coverage area and the serving mobile radio access point is deemed to be a mobile radio access point that is in position to provide radio access service to that coverage area. When a mobile radio access point is providing radio access service to a WD within a coverage area, the mobile radio access point adopts a cell identifier for use within the coverage area to allow the WD to identify the radio access link to the RAN. The cell identifier corresponds to a cell in the wireless service area. A wireless service area can include multiple coverage areas as sub-regions thereof. For example, a wireless service area can be subdivided into different coverage areas, each of which is served by a different radio access point (or a set of beams thereof). However, the entire wireless service area is cooperatively served by multiple radio access points. The wireless service area can include multiple cells as in a cellular communication system, where each cell is associated with a coverage area and where radio access service in each cell is provided by one or more radio access points.

Downlink information sent by a TBS towards a WD via a mobile radio access point may be addressed to a coverage area identifier associated with the coverage area where the WD is currently located, regardless of which mobile radio access point is currently providing radio access service to that coverage area. In addition to providing a radio access service, a mobile radio access point (e.g. a LAMP) may be further configured to perform one or more relay actions. These relay actions may include receiving, from another radio access point or from a TBS, downlink information encapsulated in a protocol data unit (PDU) addressed to the coverage area identifier. The coverage area identifier may be used as an alternative to a network address associated with the WD or with the serving mobile radio access point. The relay actions may further include transmitting the downlink information via a radio access link associated with the coverage area, or transmitting the PDU containing the downlink information towards another radio access point that is deemed to be a next-hop towards the coverage area. Forwarding and routing operations within an intermediate mobile radio access point may be based on the coverage area identifier associated with a target coverage area.

Uplink information from a WD may be forwarded by the serving mobile radio access point towards a coverage area associated with the host TBS for that WD. If the serving mobile radio access point does not have a direct communications link to the TBS, then the uplink information may be relayed through one or more intermediate mobile radio access points towards the host TBS coverage area. The host TBS coverage area identifier may be used as an alternative to a network address associated with the TBS. A mobile radio access point (e.g. a LAMP) providing a radio access service to a set of wireless devices in a served coverage area may be further configured to perform one or more relay actions. These relay actions may include receiving, via a radio access link associated with the served coverage area, uplink information from a WD in the set of wireless devices and encapsulating the uplink information in a protocol data unit (PDU) addressed to the coverage area identifier associated with the host TBS for that WD. The PDU may also include the coverage area identifier associated with the served coverage area where the WD is currently located. The relay actions may further include transmitting, to another radio access point or to the TBS, the PDU encapsulating the uplink information and addressed to the host TBS coverage area identifier.

As LAMPs in a covey travel along their flight paths, the association between coverage area and serving LAMP may change. LAMPs coordinate their operations so that radio access service to a set of WDs associated with a particular coverage area transitions from an old serving to a new serving LAMP in a manner that may be substantially transparent to the operation of WDs within that coverage area. In particular, in various embodiments, both the old serving and new serving LAMP may transmit SSBs indicating the same PCI for a cell associated with the coverage area, but each LAMP may use a different set of SSB burst set time slots, where each SSB burst set time slot represents a wireless communication beam. An SSB may include the cell identifier and the beam identifier associated with the corresponding radio access point (e.g. a LAMP). The cell identifier may include a physical cell identifier (PCI) associated with the cell in the wireless service area and the beam identifier may include a time domain transmission interval associated with the PCI. Radio access service for the PCI used to communicate with the WDs is transferred from the old serving LAMP to the new serving LAMP and an intra-cell beam switching operation may be used to establish a wireless communication link between the new serving LAMP and the set of WDs in the coverage area. The intra-cell beam switching operation may comprise a wireless device (or a set of wireless devices) ceasing to utilise a wireless communication beam, associated with one mobile radio access point, for the radio access service associated with the cell and beginning to utilise another wireless communication beam, associated with another radio access point, for the radio access service. Such beam switching operation (behaviour) is configured into a wireless device, such as a 5G UE, to recuperate from signal interference or signal loss events, for example due to the high communication frequencies in use in complicated environments. The beam switching operation is viewed by the wireless device as switching between beams associated with the same cell. By contrast, a conventional handover is viewed by the wireless device as changing from one cell to another cell. The beam switching operation does not require reconfiguration of radio resources associated with the wireless device and does not require signalling to coordinate operations in the wireless device with operations in the new serving radio access point. By contrast, a conventional handover requires reconfiguration of radio resources associated with the wireless device and requires signalling to coordinate operations in the wireless device with operations in the new serving radio access point.

Such beam switching may be accompanied by an indication from the new serving radio access point (e.g. new serving LAMP) to the old serving radio access point that the new serving radio access point has begun providing, to the set of wireless devices in the coverage area, the radio access service associated with the cell. Such indication may include an indication that the new serving radio access point is transmitting, to the set of wireless devices in the coverage area, the cell identifier (e.g. PCI) corresponding to the cell in the wireless service area and a beam identifier corresponding to a wireless communication beam associated with the new serving radio access point. Such indication may also include an indication that the new serving radio access point is transmitting, to other radio access points in the wireless service area, an announcement that the new serving radio access point has begun providing the radio access service to the coverage area. The announcement may, for example, be included in a message that is broadcast to radio access points that may be in the immediate vicinity. Such announcement may be used for forwarding and routing operations within the wireless service area.

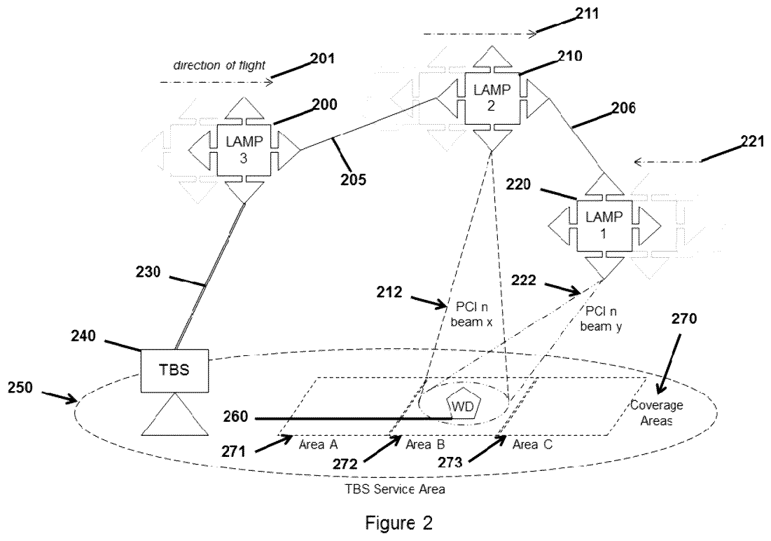

FIG. 2 illustrates the transition of a radio access service from one low-altitude mobile radio access point (LAMP) to another LAMP in an integrated terrestrial and aerial radio access network according to an example embodiment. As illustrated in FIG. 2, radio access service for the WD 260 located in coverage area B 272 is initially provided by LAMP 2 210. As LAMP 2 210 travels along its flight path 211, it moves away from coverage area B 272. At the same time, LAMP 1 220 is moving along its respective flight path 221 into position to provide radio access service to coverage area B 272. The LAMPs coordinate between themselves to facilitate the transition of radio access service from LAMP 2 210 to LAMP 1 220. From the perspective of WD 260 in coverage area B 272, LAMP 2 210 is manifested as beam x 212 in a cell associated with PCI n, while LAMP 1 220 is manifested as beam y 222 in the same cell (PCI n). When LAMP 2 210 is ready to relinquish coverage area B 272 to LAMP 1 220, the WD 260 is triggered to perform an intra-cell beam switching operation from beam x 212 to beam y 222. This removes or mitigates the need for extensive control plane signalling between a WD 260 and RAN to effect a substantially transparent transition, from LAMP 2 210 providing the radio access service to the WD 260 to LAMP 1 220 providing the radio access service to the WD 260. Relinquishing a coverage area may alternatively be referred to as transitioning or handover of a coverage area, for example.

This system, providing radio access service for a WD in a coverage area, may further include a plurality of radio access points including one or more of: a mobile radio access point (e.g. LAMP 1 210 and LAMP 2 210 in FIG. 2), a terrestrial base station (e.g. TBS 240 in FIG. 2), and a non-mobile radio access point (not shown). The plurality of radio access points may be cooperatively configured to operate as a cell associated with a specific cell identifier from a perspective of the set of wireless devices. Each radio access point in the plurality of radio access points may be associated with one or more beam identifiers selected from a set of beam identifiers associated with the cell identifier.

Information transmitted from the TBS 240 to the WD 260 may be encapsulated in a downlink protocol data unit (PDU) destined for coverage area B 272. If the TBS 240 does not have a direct link to the LAMP providing radio access service to coverage area B 272, then the downlink PDU may be relayed through one or more intermediate LAMPs (e.g. LAMP 3 200 which travels along its respective flight path 201) to the LAMP currently associated with coverage area B 272. Initially, the downlink PDUs will be relayed to LAMP 2 210 for consequent transmission of the information to the WD 260; after LAMP 2 210 relinquishes coverage area B 272 to LAMP 1 220, subsequent PDUs will be relayed to LAMP 1 220 before transmission of the information from LAMP 1 220 to the WD 260.

Accordingly, a mobile radio access point (e.g. LAMP 2 210 in FIG. 2) providing a radio access service to a set of wireless devices in a coverage area may be configured to receive, from another radio access point (e.g. LAMP 3 200 in FIG. 2) or from another device providing the radio access service (e.g. TBS 240 in FIG. 2), downlink information encapsulated in a protocol data unit associated with the coverage area identifier. The mobile radio access point may be further configured to transmit the downlink information via a wireless communication beam associated with the coverage area corresponding to the coverage area identifier. Further, a relay mobile radio access point (e.g. LAMP 3 200 in FIG. 2) that is not providing a radio access service to the coverage area may be configured to receive, from another radio access point or from another device providing the radio access service (e.g. TBS 240 in FIG. 2), downlink information encapsulated in a protocol data unit associated with the coverage area identifier. The relay mobile radio access point may be further configured to transmit the protocol data unit towards the mobile radio access point (e.g. LAMP 2 210 in FIG. 2) that is providing the radio access service to the coverage area corresponding to the coverage area identifier.

### Integrated Terrestrial and Aerial Radio Access Network

To provide service to a terrestrial device (TD) or to a low-altitude unmanned aerial vehicle (UAV) such as a commercial delivery drone, a RAN may incorporate both terrestrial base stations (TBS) and mobile radio access points. The various embodiments of the present disclosure focus on the use of LAMPs, which are mobile radio access points that may be incorporated into low-altitude unmanned aerial vehicles. Other embodiments of a mobile radio access point may, for example, include mass transit (e.g. bus, train) systems, vehicular (e.g. car, truck, taxi) platforms, and low earth orbit (LEO) satellites.

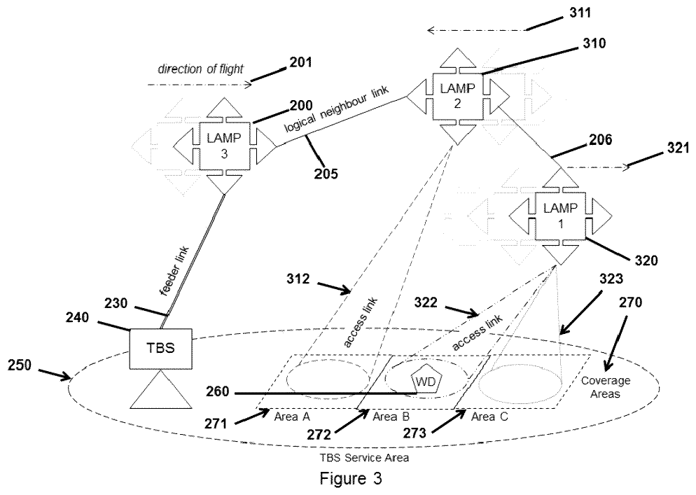

FIG. 3 illustrates the components of an integrated terrestrial and aerial radio access network according to an example embodiment. A LAMP access link 312, 322 is used to convey information between a LAMP 310, 320 and a wireless end-user device (WD) 260 such as a TD or UAV. A LAMP feeder link 230 is used to convey information between a LAMP 200 and a TBS 240. The information conveyed on a feeder link 230 may include LAMP relay traffic comprising control and user plane traffic exchanged between a WD 260 and TBS 240 and relayed through the LAMP 200. A LAMP logical neighbour link 205, 206 is used to convey information between a LAMP 200, 310 and a neighbouring LAMP 310, 320 (respectively). The information conveyed on a logical neighbour link 205, 206 may include LAMP signalling traffic used to exchange control plane information between neighbouring LAMPs. The information conveyed on a logical neighbour link 205, 206 may also include LAMP relay traffic, for example including control and user plane traffic exchanged between a WD 260 and TBS 240 and relayed through the LAMP. A TBS access link (not shown but similar to access links 312, 322) may be used to convey information directly between a TBS 240 and a WD 260 (i.e. without using a LAMP as a relay).

In some embodiments, the TBS 240 may include a control plane unit (TBS-CP) and one or more user plane units (TBS-UP). A feeder link may be used for control plane traffic between a LAMP and the TBS-CP. A different feeder link may be used for relay traffic between a LAMP and a TBS-UP.

### Low-Altitude Mobile Radio Access

A LAMP may act as a radio link extension or relay for a TBS in order to augment radio access service coverage from the TBS. In some embodiments, due to limitations of the LAMP (e.g. battery, weight, processing and memory capacity), only a subset of RAN node functions may be performed within the LAMP. In one embodiment, a LAMP may act as a regenerative relay, in accordance with the 3GPP™ Technical Report TR 38.821, “Solutions for NR to support non-terrestrial networks (NTN)” version 16.1.0, June 2021, for the exchange of information between a WD and a TBS. In some embodiments, due to capacity and latency constraints on the feeder link between a LAMP and TBS, a LAMP may provide functions related to lower layers of the radio link protocol stack (e.g. Physical Layer (PHY); Medium Access Layer (MAC); Radio Link Control (RLC)) as well as switching, routing, or both switching and routing, of relayed PDUs. Upper layer functions of the radio link protocol stack (e.g. Packet Data Convergence Protocol (PDCP); Radio Resource Control (RRC); Service Data Adaptation Protocol (SDAP)) as well as higher-level network functions may reside in the TBS.

In other embodiments, a LAMP may operate as a fully-functional aerial base station that incorporates all of the upper layer functions typically located in a TBS. In some embodiments, the TBS may function as a gateway to the terrestrial network infrastructure. In some embodiments, a LAMP may bypass the TBS and interface directly to the terrestrial network infrastructure.

In some embodiments, a LAMP may act as a forwarding node for the exchange of information between a TBS and a WD. A LAMP may be simultaneously associated with one or more TBSs, through corresponding feeder links, and with one or more WDs, through corresponding access links. If a LAMP does not have a direct feeder link to a host TBS, information between the LAMP and TBS may be relayed through intermediate LAMPs using logical neighbour links between LAMPs. A LAMP with a direct feeder link to a host TBS also has a logical neighbour link to that TBS.

Each LAMP in the covey follows a respective flight path that may be pre-determined or may be dynamically adjusted according to traffic demand or other criteria.

In some embodiments, a LAMP may follow a pre-determined flight path due, for example, to regulatory requirements or to maintain coverage over a particular geographical area.

In other embodiments, a LAMP may act autonomously to determine its flight path (within certain geographical boundaries) in order, for example, to meet pre-determined mission goals.

### Coverage Areas

In some embodiments, the service area (e.g. 250 in FIG. 3) of a network operator may be partitioned into one or more coverage areas (e.g. coverage areas 271, 272, 273 in FIG. 3 which are instances of a coverage area 270). The size of a coverage area may be based, for example, on one or more of: geolocation coordinates, characteristics of the service area (e.g. population density, traffic volume, mobility patterns, etc.), and characteristics of the LAMPs deployed in the service area (e.g. transmit power, beam width, beam steering azimuth, altitude, etc.). Each LAMP may be associated with one or more coverage areas based on the current location and altitude of the LAMP and on the characteristics of the LAMP (e.g. transmit power, number of transmit/receive chains, beamforming capabilities, etc.). For example, in FIG. 3, LAMP 1 320 may be associated with coverage areas B 272 and C 273, and LAMP 2 310 may be associated with coverage area A 271.

In some such embodiments, a LAMP may determine the coverage area associated with one of its wireless communication beams based on knowledge of its location within the service area and the orientation of its beams. The location of the LAMP may be determined by its altitude (or height above terrain) and by its position within the coordinates of the service area. The location of a LAMP may be determined dynamically using geolocation capabilities of the LAMP (e.g. global navigation satellite system, terrestrial marker recognition, cellular positioning, dead-reckoning). The orientation and width of a beam will define the terrestrial footprint of the beam which may be used to determine a region within the service area that can then be mapped onto one or more coverage areas within the service area. The wireless communication beam then constitutes a radio access link for the corresponding coverage area.

In some embodiments, if a LAMP supports multiple beams, different beams may be associated with different coverage areas or multiple beams may be associated with the same coverage area. In various embodiments, each beam is, however, associated with only one coverage area (access link) at any given time.

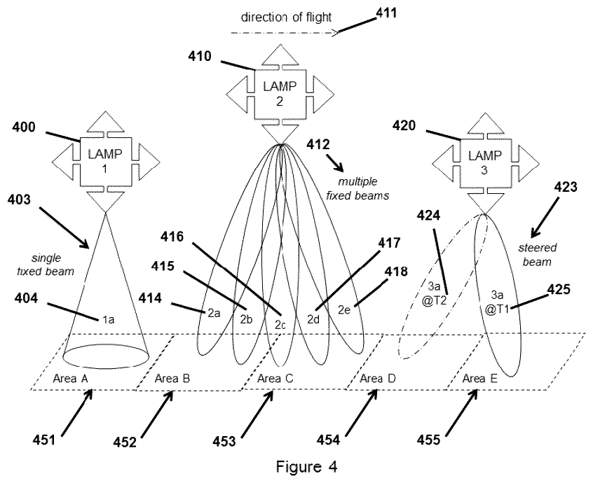

FIG. 4 illustrates some potential beam configurations for LAMPs, according to embodiments of the present disclosure. In one embodiment, as illustrated in FIG. 4, a LAMP 400 may be equipped with a single fixed beam 403 that constitutes an access link primarily providing radio access service to a single coverage area, e.g. initially to coverage area A 451 (as shown). As the LAMP 1 400 moves along its flight path 411, it provides radio access service to the next coverage area B 452 illuminated by its beam 403 and stops providing radio access service to area A 451 when it is no longer illuminated by the beam 403.

In another embodiment, as also illustrated in FIG. 4, a LAMP 2 410 may be equipped with multiple fixed beams 412 (e.g. 2a 414, 2b 415, 2c 416, 2d 417, 2e 418) that allow the LAMP 2 410 to provide radio access service to one or more coverage areas (e.g. coverage area B 452 and coverage area C 453). As the LAMP 2 410 moves along its flight path 411, radio access service to a particular coverage area may be switched to a different beam associated with the LAMP 2 410. For example, LAMP 2 410 may initially provide radio access service to coverage area B 452 through access links constituted by beams 2e 418 and 2d 417; as LAMP 2 410 moves along is flight path 411, radio access service to coverage area B 452 may be provided through beams 2d 417 and 2c 416, then through beams 2c 416 and 2b 415, and then (as shown) through beams 2b 415 and 2a 414 (shown). A LAMP with multiple beams, such as LAMP 2 410, may provide radio access service to multiple coverage areas simultaneously. For example, as shown in FIG. 4, LAMP 2 410 may provide radio access service to one coverage area (e.g. coverage area B 452) using one set of beams (e.g. beams 2a 414 and 2b 415) while simultaneously providing radio access service to another coverage area (e.g. coverage area C 453) using a different set of beams (e.g. beams 2c 416, 2d 417 and 2e 418).

In another embodiment, as also illustrated in FIG. 4, a LAMP 3 420 may be equipped with one or more steerable beams 423 that allow the LAMP 3 420 to provide radio access service to one or more coverage areas (e.g. coverage area D 454 and coverage area E 455, as shown). As the LAMP 3 420 moves along its flight path 411, radio access service to a particular coverage area may continue to be provided by a particular beam that is directed towards the coverage area; ultimately radio access service to a particular coverage area may be switched to a different beam associated with the LAMP 3 420. For example, LAMP 3 420 may provide radio access service to coverage area E 455 through instance 425 of beam 3a 423 at time T1; some time later, at time T2, LAMP 3 420 may steer beam 3a 423 to provide radio access service to coverage area D 454 via instance 424 of beam 3a. As LAMP 3 420 moves along is flight path 411, radio access service to coverage areas D 454 and E 455 may continue be provided through beam 3a 423 by steering the beam in the direction of the target coverage area at an appropriate time.

Each beam may constitute an access link that is associated with a cell identifier and a beam identifier corresponding to a wireless communication beam established between the LAMP and the set of WDs in the coverage area. The beam identifier may be selected from a set of beam identifiers associated with the cell identifier.

As will be readily understood by a worker skilled in the art, directed radio beams can be generated using analogue and digital beamforming techniques, multi-input multi-output (MIMO) array techniques, certain antenna size and shape configuration, use of reflectors, directors, or the like, or a combination thereof.

### Cells

Each wireless communication beam of a radio access point is associated with a physical cell identifier (PCI). In various embodiments, when a radio access point provides a radio access service to a coverage area, it transmits (e.g. broadcasts) an indication that the radio access point (e.g. a LAMP) is providing a radio access service in order to access a wireless communication service. The indication may be in the form of a synchronisation signal block (SSB) that reflects the PCI associated with the access link. Each beam of a radio access point that is associated with a given cell (PCI) is identified by an SSB time index reflected in the physical broadcast channel (PBCH) of the SSB, in accordance with the 3GPP™ Specification TS 38.300, “NR and NG-RAN Overall Description; Stage 2” version 16.8.0, December 2021. Within a given cell (PCI), different beams will be associated with different SSB time indexes. Thus, the indication (e.g. SSB) may include a cell identifier such as the PCI and may include a beam identifier such as an SSB time index.

The PCI associated with a cell may be determined by a radio access point using one of several mechanisms.

In an embodiment, the PCI associated with a cell may be determined by a mobile radio access point by pre-configuration, where, for example, a database may be used to identify the PCI to be associated with a coverage area. The database may be established, for example, through network engineering procedures.

In an embodiment, the PCI associated with a cell may be determined by a mobile radio access point by algorithm, where an identifier or attribute associated with the coverage area may be used to derive a corresponding PCI. The algorithm may, for example, use a hashing function to derive a PCI from one or a combination of coverage area attributes that include a coverage area identifier.

In an embodiment, the PCI associated with a cell may be determined by a mobile radio access point by random selection, where the PCI may be randomly selected from a set of candidate PCIs. The set of candidate PCIs may, for example, be pre-configured based on the current location of the mobile radio access point or the set of candidates may reflect PCIs that are not currently being used by any mobile radio access point within a k-hop neighbourhood of the current serving mobile radio access point.

In another embodiment, the PCI associated with a cell may be determined by a mobile radio access point by transition of coverage area access services, where the PCI may be provided to an incoming LAMP when the current serving mobile radio access point makes a determination to relinquish control of radio access service for the coverage area to the incoming mobile radio access point, as detailed elsewhere herein.

A WD does not necessarily have knowledge of coverage areas nor does a WD necessarily have explicit knowledge of mobile radio access points. When attempting to establish an access link with a RAN, a WD may perform a conventional cell selection by searching for an SSB broadcast in a local cell, in accordance with the 3GPP™ Specification TS 38.300, “NR and NG-RAN Overall Description; Stage 2” version 16.8.0, December 2021. Once an access link connection to a selected cell has been established, the WD may monitor the signal quality on the downlink beams indicated by the cell (e.g. as SSB time indexes) to determine the best beam to use for its access link.

Upon determining the initial beam to use for its access link, the beam switching operation may involve the WD determining that the signal quality of the initial beam has fallen below a pre-determined threshold, identifying a second beam where the signal quality of the second beam is above a pre-determined threshold, ceasing to utilise the initial beam for the radio access service associated with the cell, and beginning to utilise the second beam for the radio access service associated with the cell. The initial beam and the second beam may be associated with the same radio access point or with different radio access points.

A mobile radio access point may associate a coverage area with a WD based on the access link (beam) used to communicate with the WD. The coverage area encompassing the WD is reported to the host TBS to identify the relay point for subsequent transmissions between the TBS and the WD.

### Transition of Coverage Area Access Services

The characteristics of a LAMP—low altitude, low transmit power for energy conservation, use of higher frequency spectrum—may result in a small terrestrial coverage footprint (i.e. a small cell diameter). The small cell size means that the time available for a mobile LAMP to provide radio access service to a coverage area will be correspondingly reduced. This may be exacerbated if a mobile WD and a mobile LAMP are moving quickly in relation to each other, such that the combined relative velocities result in more frequent transition of radio access service between LAMPs.

Conventionally, a WD monitors downlink reference signals transmitted from the RAN in order to determine the available cells. The WD provides measurement reports to the RAN to allow the network to select the best cell to be associated with the WD. Once a target cell has been selected, the RAN coordinates a handover to the newly-selected cell through signalling to the WD and signalling between the affected RAN network elements.

If the conventional handover technique is used to coordinate the transition of radio access service between mobile radio access points, then the frequent handovers can result in significant control plane signalling and associated delays. To mitigate these issues, a network-centric transition of radio access service may be used by mobile radio access points that mitigates or minimises control plane interaction with a WD.

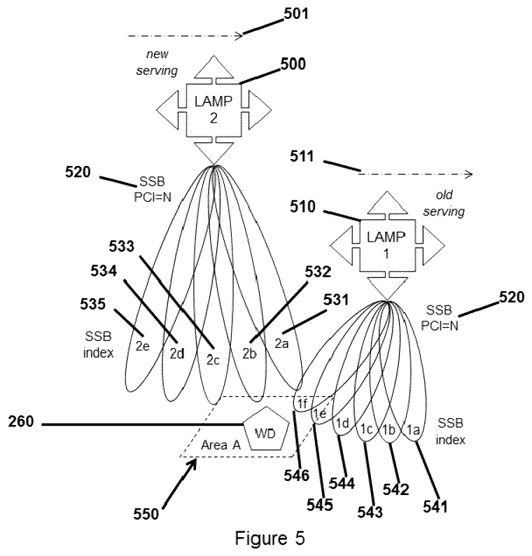

The transition of coverage area radio access service from one LAMP to another LAMP may be substantially transparent from the perspective of the WDs within the coverage area. As illustrated in FIG. 5, the old serving LAMP 1 510 and new serving LAMP 2 500 are both associated with the same physical cell identifier (PCI) 520 but are associated with different beams within that cell. Each beam may be associated with a time slot index indicating a unique time domain transmission interval associated with the same PCI. A change in the serving LAMP may be coordinated as a change in the downlink beam seen (or used) by the WD 260.

The old serving LAMP 1 510 in FIG. 5 may broadcast an SSB burst set for the PCI using a subset of the SSB time slots (indexes) associated with the PCI. This subset of SSB time slots (indexes) (e.g. 1a 541, 1b 542, 1c 543, 1d 544, 1e 545, 1f 546) is different from the subset of SSB time slots (indexes) used by the incoming new serving LAMP 2 500 in an SSB burst set for the PCI (e.g. 2a 531, 2b 532, 2c 533, 2d 534, 2e 535). Additionally or alternatively, the different beams corresponding to different SSB time slots (indexes) may be referred to for purposes of discussion as beams 1a 541, 1b 542, 1c 543, 1d 544, 1e 545, 1f 546, 2a 531, 2b 532, 2c 533, 2d 534, 2e 535.

In an embodiment, the allocation of SSB time slots (indexes) to the old and new serving LAMPs may be pre-configured.

In an embodiment, the allocation of SSB time slots (indexes) to the old and new serving LAMPs may be self-allocated using a pre-determined mechanism. For example, in a numerology with N SSB time slots (indexes) in a burst set, M SSB time slots may be reserved for use by the old serving LAMP and (N−M) SSB time slots may be reserved for use by the new serving LAMP.

In an embodiment, the allocation of SSB time slots (indexes) to the old and new serving LAMPs may be dynamically allocated to the new serving LAMP by the old serving LAMP during the coverage area transition procedure based on a set of currently unused SSB time slots (indexes) in an SSB burst set. This implies that a serving LAMP should always keep at least SSB_{MIN} (¿0) time slots (indexes) available for allocation during transition of radio access service for a coverage area.

When an old serving LAMP relinquishes radio access service for a coverage area to an incoming candidate LAMP, the old serving LAMP may provide the new candidate LAMP with the access link context associated with each of the WDs that it is serving within the coverage area being relinquished. When the new candidate LAMP is ready to assume responsibility for providing radio access service within the coverage area, it may begin to transmit downlink reference signals corresponding to a beam (e.g. an SSB containing a time index associated with the beam) of the cell associated with the coverage area. Concurrently, the old serving LAMP may configure the WD for discovery of the new beam. At this point, the old serving LAMP may take one or more actions to ensure that it is no longer providing radio access service to WDs in the coverage area. Subsequent communications with the WD over the access link may then utilise the beam corresponding to the new serving LAMP.

In various embodiments, the actions, which ensure that the old serving LAMP is no longer providing radio access service to a set of WDs in the coverage area, also contribute to causing the set of WDs in the coverage area to perform a beam switching operation. According to the beam switching operation, the WDs cease to utilise the attendant beams of the old serving LAMP for the radio access service and begin to utilise the attendant beams of the new serving LAMP for the radio access service. The actions of the old serving LAMP may include reducing a strength of communication signals associated with the beam that the old serving LAMP was using to provide radio access service to the set of WDs. Reducing the strength of communication signals may be accomplished by one or a combination of: motion of the LAMP away from the coverage area; directing the beam away from the coverage area; decreasing a transmission power associated with the beam; inhibiting transmission to the set of wireless devices in the coverage area of at least one of the cell identifier (e.g. PCI) and attendant beam identifiers (e.g. SSB time indexes); and inhibiting transmission of downlink reference signals associated with the beam (e.g. an SSB containing a corresponding PCI and SSB time index). Such actions generally cause WDs to view the beams of the old serving LAMP as absent, insufficient or unreliable, thus triggering the beam switching operation according to pre-configured behaviours.

From the perspective of a WD located in the coverage area, the old serving LAMP and the new serving LAMP may appear as different beams within a cell associated with a same physical cell identifier (PCI) (i.e. a first beam corresponding to a first SSB time index that is associated with the old serving LAMP and second beam corresponding to a second SSB time index that is associated with the new serving LAMP). The transition of radio access service from the old serving LAMP to the new serving LAMP may be manifested as a change in the access link beam used by the WD (i.e. higher layer configurations above PHY are not changed), thus reducing or eliminating the delays and signalling overheads associated with a conventional handover.

From the perspective of the TBS, the transition of radio access service from the old serving LAMP to the new serving LAMP is transparent, meaning for example that it is not material to operation of the TBS which LAMP is being used to provide the radio access service to the coverage area. This transparency of the transition of radio access service from the perspective of the TBS is possible as a result of the old and new serving LAMPs being both associated with the same coverage area identifier for relaying operations.

### Detailed Transition Procedure

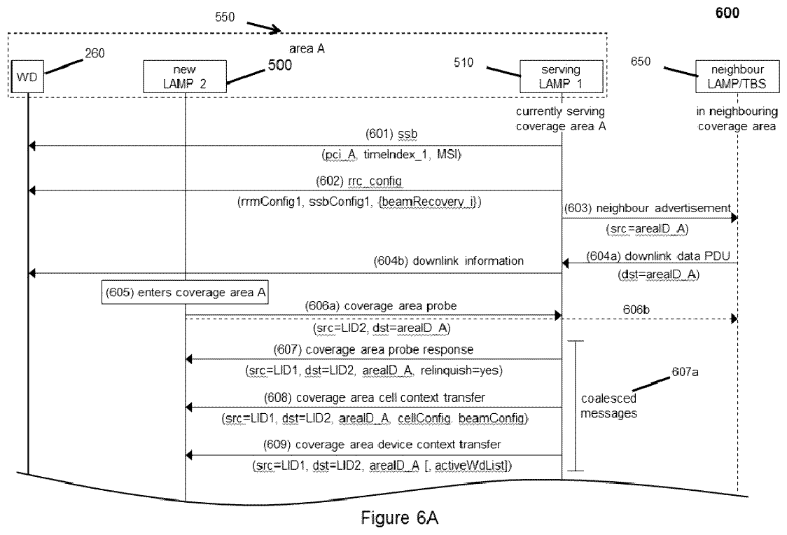

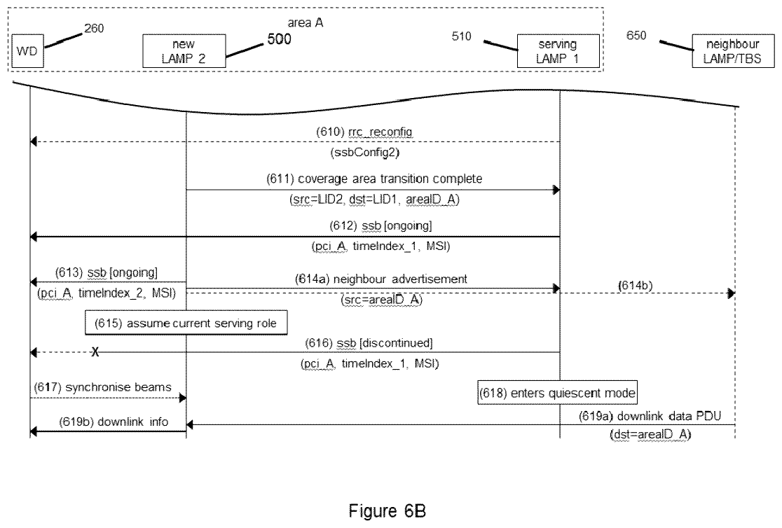

FIGS. 6A and 6B illustrate an example procedure 600 with a set of operations for the transition of radio access service for a coverage area.

In various embodiments, the set of operations may be performed substantially in the order presented. In other embodiments, the set of operations may be performed in a different order without affecting the outcome of the procedure.

In step 601, while providing radio access service to a coverage area (e.g. area A 550), a serving LAMP (e.g. LAMP 1 510) broadcasts an SSB associated with the cell corresponding to the access link providing service to that coverage area. As illustrated, the SSB may include an indication of the PCI associated with the cell (e.g. pci_A), the SSB time slot index associated with the beam (e.g. timeindex_1), and the minimum system information (MSI) associated with the cell.

In step 602, the serving LAMP (LAMP 1 510) also provides each WD in the set of served WDs 260 with radio resource management information for operation within the cell, including an indication of the SSB time slot indexes (beams) associated with an access link of the serving LAMP 1 510. As illustrated, this may be done via a radio resource control (RRC) configuration message (rrc_config) which may include parameters such as radio resource configuration (rrmConfig1), SSB burst set configuration (ssbConfig1), and beam recovery configuration (beamRecovery_i).

In step 603, the serving LAMP (LAMP 1 510) also broadcasts neighbour advertisements (as detailed elsewhere herein) to one or more neighbouring LAMPs 650 (which may include the TBS 240) to identify the one or more coverage areas where the LAMP (LAMP 1 510) is providing a radio access service. The neighbour advertisements may include a parameter indicating the source of the advertisement, expressed as the identity of the served coverage area (e.g. src=areaID_A).

In step 604, downlink information destined for a WD 260 is encapsulated in a downlink data PDU (as detailed elsewhere herein) that is addressed using the identity of the coverage area (area A 550) where the WD 260 is currently located (e.g. dst=areaID_A). The downlink data PDU, based on the neighbour advertisements (e.g. in step 603), is forwarded (in step 604a) by the TBS, possibly through intermediate LAMPs 650, to the LAMP (LAMP 1 510) broadcasting responsibility for that coverage area in its neighbour advertisements. When received by the LAMP serving the coverage area (LAMP 1 510), the downlink information is extracted from the downlink data PDU and forwarded (in step 604b) to the target WD 260.

In step 605, at some point in time, another LAMP (LAMP 2 500) moves into position to potentially provide radio access service to the coverage area (area A 550).

In step 606, the newly arrived LAMP (LAMP 2 500) broadcasts a coverage area probe (as detailed elsewhere herein) to determine if there is another LAMP already providing radio access services to the coverage area (area A 550). The coverage area probe 606a may include parameters such as the identity of the target coverage area (e.g. dst=areaID_A) and an identifier indicating the source of the coverage area probe (e.g. src=LID2). The source identifier associated with the newly arrived LAMP (LAMP 2 500) may, for example, be a random number chosen to avoid conflicts with a coverage area identifier or may be derived from another identifier associated with the LAMP (e.g. a serial number). The coverage area probe may be interpreted by LAMP 1 as an indication that LAMP 2 is able to provide the radio access service to the coverage area.

After receiving the coverage area probe, the current serving LAMP (LAMP 1 510) determines whether it will relinquish control of the coverage area (area A 550). This determination may be based, for example, on its remaining fuel or battery power, on its intended flight path, on the type of radio access service currently being provided to WDs in the coverage area, or on whether the LAMP is tethered to the coverage area and unable to move. Other LAMPs that are not providing radio access service to the coverage area identified in the coverage area probe (e.g. neighbour LAMPs 650) may also receive the broadcast coverage area probe 606b but will ignore it since the probe is not related to a coverage area that they serve.

In step 607, after determining whether it will relinquish control of the coverage area (area A 550), the current serving LAMP (LAMP 1 510) indicates that radio access service is currently being provided to the coverage area (area A 550) by responding to the coverage area probe with a coverage area probe response (as detailed elsewhere herein), indicating that it will (or alternatively will not) relinquish control of the coverage area (area A 550), i.e. that it will relinquish providing of the radio access service to the coverage area. The coverage area probe response will be addressed to the identifier provided by the incoming LAMP in its coverage area probe (dst=LID2) and will include a source identifier (src=LID1) associated with the current serving LAMP (LAMP 1 510) which may, for example, be a random number chosen to avoid conflicts with a coverage area identifier, or may be derived from another identifier associated with the LAMP (e.g. a serial number). The coverage area probe response will also include a confirmation of the coverage area identifier included in the coverage area probe (areaID_A) and an indication (e.g. yes or no) of whether the serving LAMP will relinquish control of the coverage area (e.g. relinquish=yes).

In step 608, if the current serving LAMP (LAMP 1 510) has indicated that it will relinquish control of radio access service for the coverage area (area A 550), it initiates the transfer of coverage area cell context information (as detailed elsewhere herein) to the candidate LAMP (LAMP 2 500). This coverage area cell context information may include parameters such as the SSB configuration of the cell (cellConfig), including the PCI and MSI, and a beam configuration for the cell (beamConfig). The beam configuration may indicate the set of beams (i.e. SSB time slot indexes) currently used by the serving LAMP (LAMP 1 510) in its SSB burst set or may indicate the set of beams available to the candidate LAMP (LAMP 2 500). Thus, the message may include some or all of the set of beam identifiers associated with the cell identifier.

Based on this coverage area cell context information, the candidate LAMP (LAMP 2 500) may determine which of the available SSB time slots (indexes) can be used for its beams to provide radio access service using the PCI associated with the target coverage area (area A 550). Thus the candidate LAMP (LAMP 2 500) can self-configure for providing radio access service to the target coverage area (area A 550).

In step 609, the current serving LAMP (LAMP 1 510) also initiates the transfer of device-specific context information (as detailed elsewhere herein) to the candidate LAMP (LAMP 2 500) for each WD 260 with an active access link connection to the cell associated with the coverage area (area A 550). For each WD in the list of active WDs (activeWdList) this context information may include, for example, the identity of the host TBS for the WD, assigned radio resources, assigned RAN-specific identifiers such as a cell radio network temporary identifier (C-RNTI) and an inactive mode radio network temporary identifier (I-RNTI), radio resource configuration parameters, security association configuration, and such. Thus, the current serving LAMP may indicate, to the candidate LAMP, the set of wireless devices in the coverage area and radio resource configuration information for each of these wireless devices.

Note that the messages described in steps 607, 608 and 609 may be transmitted as individual datagrams (as shown in FIG. 6A) or the messages may be coalesced into a single datagram 607a depending on the capacity of the logical neighbour link.

In step 610, the current serving LAMP (LAMP 1 510) may, if necessary, send updated radio resource management information to the served WDs 260 (e.g. in an RRC reconfiguration message) indicating, for example, the SSB time slot indexes (ssbConfig2) that will be used by the candidate LAMP (LAMP 2 500).

In step 611, once the transfer of coverage area context information is complete and the candidate LAMP (LAMP 2 500) is ready to assume responsibility for radio access service within the coverage area (area A 550), the candidate LAMP (LAMP 2 500) sends to the current serving LAMP (LAMP 1 510) an indication that preparation for coverage area transition of the targeted coverage area (areadID_A) is complete (as detailed elsewhere herein).

In step 612, and in steps 602 through 611 discussed above, the current serving LAMP (LAMP 1 510) may continue, as in step 601, to broadcast an SSB encoded with the PCI associated with the coverage area (area A 550) in each of the SSB time slots (indexes) allocated to the current serving LAMP (timeindex_1).

In step 613, the candidate LAMP (LAMP 2 500) begins to broadcast an SSB encoded with the same PCI (as in step 612) in each of the SSB time slots (indexes) allocated to the candidate LAMP (timeindex_2) as determined in step 608.

In steps 614, the candidate LAMP (LAMP 2 500) also begins to broadcast neighbour advertisements 614a and 614b (as detailed elsewhere herein) to neighbouring LAMP 1 510 and to other possible neighbouring LAMPs 650, respectively, to indicate that it is now the destination for all information related to the newly-acquired coverage area (area A 550). As in step 603, the neighbour advertisements may include the source of the advertisement, expressed as the identity of the served coverage area (e.g. src=areaID_A) In step 615, the candidate LAMP (LAMP 2 500) assumes the role of new serving LAMP for the advertised coverage area (area A 550).

In step 616, when the old serving LAMP (LAMP 1 510) determines that the candidate LAMP (LAMP 2 500) has assumed the role of new serving LAMP for the coverage area (area A 550) (e.g. by detecting, in step 614, the transmission of a neighbour advertisement for the coverage area (area A 550) from the new serving LAMP (LAMP 2 500)), the old serving LAMP (LAMP 1 510) may take actions to ensure that it is no longer providing radio access service to WDs 260 in the coverage area (area A 550). As described elsewhere herein, this may include stopping the transmission of SSBs associated with the PCI of the coverage area (area A 550) in each of the SSB time slots (indexes) allocated to the old serving LAMP (timeindex_1).

In step 617, WDs 260 that fail to detect an SSB in an SSB time slot (index) associated with the old serving LAMP (LAMP 1 510) will synchronise with an SSB transmitted in an SSB time slot (index) associated with the new serving LAMP (LAMP 2 500) and begin to access the radio access service through the corresponding access link beam. Thus the WDs are caused to perform a beam switching operation, whereby the WDs cease to utilise the beam(s) of the old serving LAMP for the radio access service and begin to utilise the beam(s) of the new serving LAMO for the radio access service.

In step 618, the old serving LAMP (LAMP 1 510) will stop the transmission of neighbour advertisements for the coverage area (area A 550) and will enter a quiescent mode with respect to the relinquished coverage area (area A 550).

Following step 618, the old serving LAMP (LAMP 1 510) may still provide access services to other coverage areas through the transmission of SSBs and neighbour advertisements associated with those other coverage areas.

In step 619, downlink information destined for a WD 260 operating within the coverage area (area A 550) is encapsulated in a downlink data PDU (as detailed elsewhere herein) that is addressed using the identity of the coverage area (e.g. dst=areaID_A). The downlink data PDU, based on the neighbour advertisements (e.g. in step 614), is forwarded (in step 619a) to the new serving LAMP (LAMP 2 500) by the TBS, possibly through intermediate LAMPs 650. When received by the new serving LAMP (LAMP 2 500), the downlink information is extracted from the downlink data PDU and forwarded (in step 619b) to the target WD 260.

In various embodiments, the procedure illustrated in FIGS. 6A and 6B may be the same regardless of the number of WDs 260 currently active within the coverage area 550. Thus the number of signalling messages, exchanged between mobile radio access points to effect a transition, may be the same regardless of the number of WDs currently active within a coverage area. The use of conventional signals that are broadcast to all WDs in a coverage area may also contribute to ensuring that the number of signalling messages exchanged between mobile radio access points and WDs to effect a transition is effectively the same regardless of the number of WDs currently active within a coverage area. This contrasts conventional handover procedures, where the volume of signalling messages exchanged between mobile radio access points and between mobile radio access points and WDs is proportional to the number of WDs currently active within a coverage area.

### Nu (logical Neighbour) Protocol Data Units

Embodiments of the present disclosure will now be described with respect to protocol data units (PDUs) used to convey information over a logical neighbour link 205, 206 between RAN nodes, for example to facilitate the procedure of FIGS. 6A and 6B. As used herein, an Nu reference point may refer to a logical interface between neighbouring LAMPs or between a LAMP and a TBS.

In an embodiment, an Nu PDU may convey higher-layer information associated with a particular coverage area to a RAN node (i.e. a LAMP or TBS). An Nu PDU may include an identifier associated with the coverage area and may be forwarded by a receiving node to another RAN node in the direction of the coverage area identified as the destination for an Nu PDU.

The disposition of the Nu PDU when it arrives at a RAN node providing radio access service to the destination coverage area may be determined by the type of Nu PDU, or by information in an Nu PDU payload field, or by a combination thereof. For example, a RAN node associated with the destination coverage area may, for a particular type of an Nu PDU, process the information in the Nu PDU payload and then discard the Nu PDU, indicating successful delivery of information in the Nu PDU to its destination. In other instances, a RAN node associated with the destination coverage area may, for a particular type of Nu PDU, forward information contained in the Nu PDU payload towards one or more end-user wireless devices currently located within the associated coverage area(s).

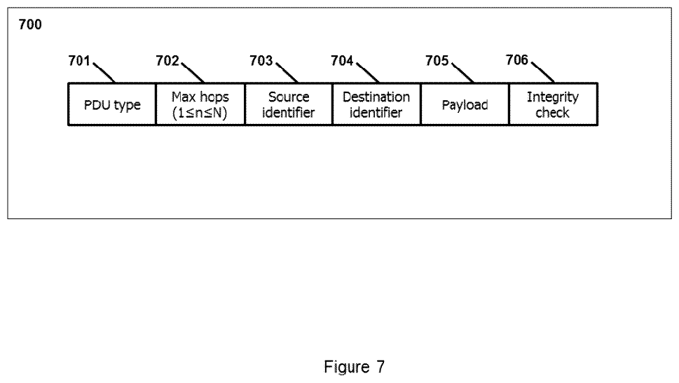

Generically, as illustrated in FIG. 7, an Nu PDU 700 may include a PDU type field 701 that identifies the type of PDU and indicates how the remaining fields in the PDU should be interpreted.

An Nu PDU may include a maximum hops remaining field 702 set by the originator of the PDU to a predetermined value. Each of the forwarding RAN nodes decrements the value of the maximum hops remaining field 702 before forwarding the PDU. If the value of the maximum hops remaining field 702 reaches zero (0) before arriving at a RAN node associated with the PDU's destination identifier 704, the PDU may be (silently) discarded.

An Nu PDU may include a source identifier field 703 that indicates an identifier associated with the originator of the PDU.

An Nu PDU may include a destination identifier field 704 that indicates an identifier associated with the destination of the PDU.

An Nu PDU may include a PDU payload field 705 that contains information to be processed by one or more RAN nodes associated with the destination identifier 704. A PDU payload field 705 may also contain information to be processed by one or more intermediate RAN nodes that relay the PDU towards the destination identifier 704.

An Nu PDU may include a PDU integrity check field 706 that can be used to verify that the PDU was created by an authorised forwarding RAN node associated with the service area, and that the PDU has not been modified by an intervening entity between the originating and destination nodes.

### Neighbour Advertisement

A neighbour advertisement may be sent by a source RAN node (transmitter) to advertise the source node's presence as a coverage area serving node to neighbouring RAN nodes (receivers) within its transmission range (i.e. to neighbouring nodes that are one transmission hop from the transmitter). Neighbour advertisements are not necessarily forwarded by receivers to other RAN nodes. A neighbour advertisement is not necessarily explicitly acknowledged by a receiver - a receiver may trigger transmission of a reciprocal neighbour advertisement in response to a received neighbour advertisement, or the transmitter may rely on periodic transmission of a neighbour advertisement to inform neighbours of its presence.

A neighbour advertisement may be used by a RAN node that receives the advertisement to identify the neighbouring node that is providing radio access service to a particular coverage area, or to identify the next-hop relay along the path towards a particular coverage area.

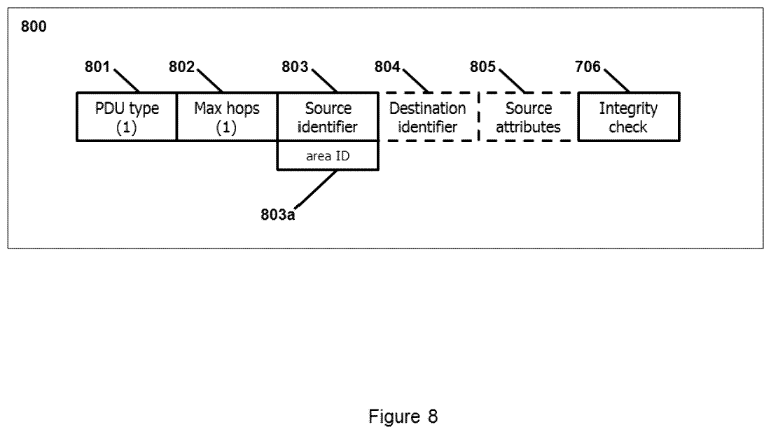

As illustrated in FIG. 8, a Neighbour Advertisement PDU 800 may include a PDU type field 801 that identifies the PDU as a Neighbour Advertisement PDU (e.g. type 1).

A Neighbour Advertisement PDU may include a maximum hops remaining field 802 set by the originator of the Neighbour Advertisement PDU to the value of 1 (one), indicating that the PDU should not be forwarded by a one-hop neighbour.

A Neighbour Advertisement PDU may include a source identifier field 803 that indicates the coverage area identifier 803a associated with the originator of the PDU.

A Neighbour Advertisement PDU may include an optional destination identifier field 804 that, if present, indicates the identifier associated with the destination of the Neighbour Advertisement PDU. If the optional destination identifier field 804 is not provided, then the Neighbour Advertisement PDU is intended as a broadcast to all listening neighbours.

A Neighbour Advertisement PDU may include an optional PDU payload field 805 that, if present, may contain source node attributes related to the transmitter of the PDU.

The Neighbour Advertisement PDU of FIG. 8 may also include an integrity check field 706 which may be as described above with respect to FIG. 7.

### Coverage Area Probe

In various embodiments, when an incoming LAMP is in position to provide radio access service to a coverage area, a coverage area probe may be broadcast by the incoming LAMP to determine if a neighbouring RAN node is already providing radio access service to the target coverage area.

The coverage area probe may elicit a coverage area probe response (as described elsewhere herein) from a RAN node currently providing radio access service to the target coverage area. If the coverage area probe is received by a RAN node that is not currently providing access service to the target coverage area, then the received coverage area probe may be (silently) discarded and ignored (i.e. a coverage area probe is not forwarded by a receiving RAN node).

In various embodiments, failure to receive a response to the coverage area probe may be interpreted, by the incoming LAMP, as an indication to the incoming LAMP that the target coverage area is not currently served by a RAN node.

Reception of a neighbour advertisement, such as one illustrated in FIG. 8 and associated with the target coverage area, may be interpreted, by the incoming LAMP, as an indication to the incoming LAMP that the target coverage area is currently served by a RAN node and the coverage area probe must be repeated before the incoming LAMP attempts to assume responsibility for radio access service in the target coverage area.

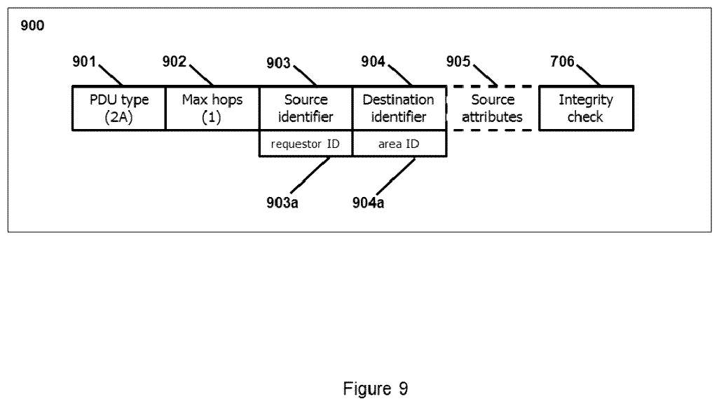

As illustrated in FIG. 9, a Coverage Area Probe PDU 900 may include a PDU type field 901 that identifies the PDU as a Coverage Area Probe PDU (e.g. type 2A).

A Coverage Area Probe PDU may include a maximum hops remaining field 902 set by the originator of the Coverage Area Probe PDU to the value of 1 (one), indicating that the PDU should not be forwarded by a one-hop neighbour.

A Coverage Area Probe PDU may include a destination identifier field 904 that indicates the target coverage area identifier 904a associated with the coverage area probe.

A Coverage Area Probe PDU may include a source identifier field 903 that contains an identifier 903a selected by the originator of the coverage area probe as a requestor transaction identifier to correlate PDUs associated with a particular coverage area transition procedure. The requestor transaction identifier 903a should be chosen to avoid collision with coverage area identifiers used within the service area. The requestor transaction identifier 903a may, for example, be a random number or may be derived from another identifier associated with the originator (e.g. a serial number).

A Coverage Area Probe PDU may include an optional PDU payload field 905 that, if present, may contain source node attributes related to the transmitter of the PDU.

The Coverage Area Probe PDU of FIG. 9 may also include an integrity check field 706 which may be as described above with respect to FIG. 7.

### Coverage Area Probe Response

A coverage area probe response may be transmitted in response to a coverage area probe (e.g. as illustrated in FIG. 9) as an indication to an incoming LAMP that the target coverage area is currently served by a RAN node. The coverage area probe response may also indicate whether the RAN node currently providing radio access service to the target coverage area will be relinquishing control of the coverage area at this time. For example, a RAN node that is tethered to a particular coverage area (e.g. a non-mobile node such as a TBS or a mobile LAMP that is hovering in position over a coverage area) may determine not to relinquish control of a coverage area to an incoming LAMP. A RAN node that is not relinquishing control of the coverage area may also transmit a neighbour advertisement (e.g. as illustrated in FIG. 8) to indicate that it is already providing radio access service to the targeted coverage area.

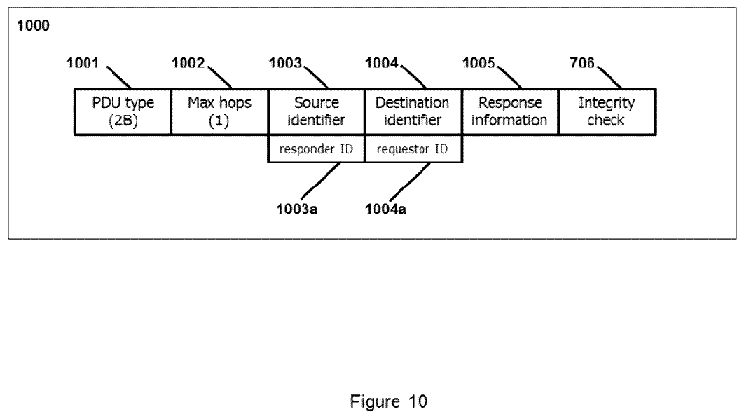

As illustrated in FIG. 10, a Coverage Area Probe Response PDU 1000 may include a PDU type field 1001 that identifies the PDU as a Coverage Area Probe Response PDU (e.g. type 2B).

A Coverage Area Probe Response PDU may include a maximum hops remaining field 1002 set by the originator of a Coverage Area Probe Response PDU to the value of 1 (one), indicating that the PDU should not be forwarded by a one-hop neighbour.

A Coverage Area Probe Response PDU may include a source identifier field 1003 that contains an identifier 1003a selected by the current serving LAMP as a responder transaction identifier to correlate PDUs associated with a particular coverage area transition procedure. The responder transaction identifier 1003a should be chosen to avoid collision with coverage area identifiers used within the service area. The responder transaction identifier 1003a may, for example, be a random number or may be derived from another identifier associated with the responder (e.g. a serial number).

A Coverage Area Probe Response PDU may include a destination identifier field 1004 that reflects the requestor transaction identifier 903a used as the source identifier 903 in a corresponding Coverage Area Probe PDU 900 (i.e. the requestor transaction identifier 1004a should be the same as the requestor transaction identifier 903a).

A Coverage Area Probe Response PDU may include a PDU payload field 1005 that contains coverage area coordination information.

The PDU payload of the Coverage Area Probe Response PDU may contain an indication of whether the originator of a Coverage Area Probe Response PDU is relinquishing or is not relinquishing control of the coverage area at this time.

If, based on the indication, control is being relinquished, then the current serving LAMP may initiate transfer of context information to the incoming LAMP with a subsequent coverage area context transfer, as described further herein.

If, based on the indication, control is not being relinquished, then (in various embodiments) no further coverage area transition PDUs are exchanged and the transaction indicated by the requestor transaction identifier 1004a (in the destination identifier field 1004) is terminated. The incoming LAMP may initiate another coverage area probe, as described previously herein, at a later time using a different requestor transaction identifier.

The PDU payload of the Coverage Area Probe Response PDU may contain a time delay value indicating deferral of the coverage area transition to a later time (as indicated by the time delay value), if control is being relinquished, or the minimum time before a new request will be considered, if control is not being relinquished.

The PDU of FIG. 10 may also include an integrity check field 706 which may be as described above with respect to FIG. 7.

### Coverage Area Cell Context Transfer

A current serving LAMP that determines to relinquish control of a coverage area may provide cell-specific radio resource information to an incoming candidate LAMP to facilitate substantially transparent continuity of radio access service within the target coverage area by the candidate LAMP.

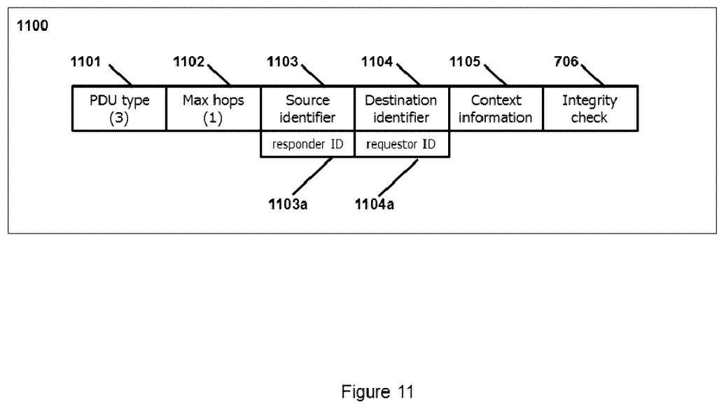

As illustrated in FIG. 11, a Coverage Area Cell Context Transfer PDU 1100 may include a PDU type field 1101 that identifies the PDU as a Coverage Area Cell Context Transfer PDU category (e.g. type 3).

A Coverage Area Cell Context Transfer PDU may include a maximum hops remaining field 1102 set by the originator of a Coverage Area Cell Context Transfer PDU to the value of 1 (one), indicating that the PDU should not be forwarded by a one-hop neighbour.

A Coverage Area Cell Context Transfer PDU may include a source identifier field 1103 that contains the responder transaction identifier 1103a used by the current serving LAMP to correlate PDUs associated with a particular coverage area transition procedure. The responder transaction identifier 1103a should be the same as the responder transaction identifier 1003a used in the source identifier field 1003 of the Coverage Area Probe Response PDU 1000.

A Coverage Area Cell Context Transfer PDU may include a destination identifier field 1104 that contains the requestor transaction identifier 1104a used by the candidate LAMP to correlate PDUs associated with a particular coverage area transition procedure. The requestor transaction identifier 1104a should be the same as the requestor transaction identifier 903a used in the source identifier field 903 of the Coverage Area Probe PDU 900.

A Coverage Area Cell Context Transfer PDU may include a PDU payload field 1105 that contains radio resource information configured by the current serving LAMP for use within the cell associated with the target coverage area.

The PDU of FIG. 11 may also include an integrity check field 706 which may be as described above with respect to FIG. 7.

### Coverage Area Device Context Transfer

A current serving LAMP may provide device-specific context and radio resource information to an incoming candidate LAMP to facilitate substantially transparent continuity of radio access service to an active WD by the candidate LAMP.

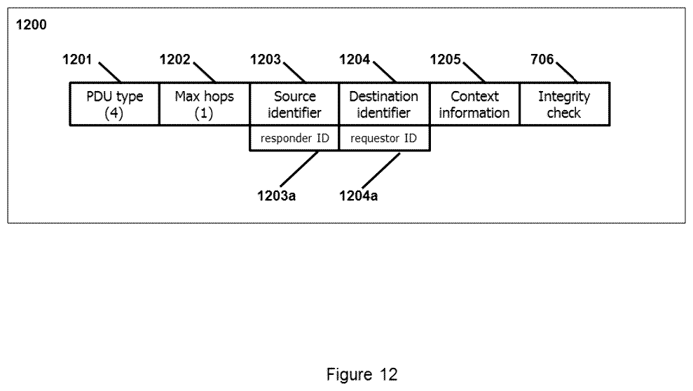

As illustrated in FIG. 12, a Coverage Area Device Context Transfer PDU 1200 may include a PDU type field 1201 that identifies the PDU as a Coverage Area Device Context Transfer PDU (e.g. type 4).

A Coverage Area Device Context Transfer PDU may include a maximum hops remaining field 1202 set by the originator of a Coverage Area Device Context Transfer PDU to the value of 1 (one), indicating that the PDU should not be forwarded by a one-hop neighbour.

A Coverage Area Device Context Transfer PDU may include a source identifier field 1203 that contains the responder transaction identifier 1203a used by the current serving LAMP to correlate PDUs associated with a particular coverage area transition procedure. The responder transaction identifier 1203a should be the same as the responder transaction identifier 1003a used in the source identifier field 1003 of the Coverage Area Probe Response PDU 1000.

A Coverage Area Device Context Transfer PDU may include a destination identifier field 1204 that contains the requestor transaction identifier 1204a used by the candidate LAMP to correlate PDUs associated with a particular coverage area transition procedure. The requestor transaction identifier 1204a should be the same as the requestor transaction identifier 903a used in the source identifier field 903 of the Coverage Area Probe PDU 900.

A Coverage Area Device Context Transfer PDU may include a PDU payload field 1205 that contains device-specific context information associated with each of the served WDs.

The PDU of FIG. 12 may also include an integrity check field 706 which may be as described above with respect to FIG. 7.

### Coverage Area Transition Complete

An incoming candidate LAMP may signal its readiness to assume the role of serving LAMP by transmitting a Coverage Area Transition Complete PDU to the current serving LAMP.

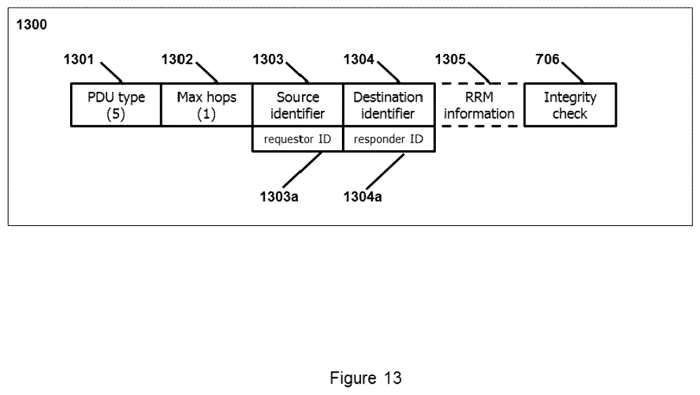

As illustrated in FIG. 13, a Coverage Area Transition Complete PDU 1300 may include a PDU type field 1301 that identifies the PDU as a Coverage Area Transition Complete PDU (e.g. type 5).

A Coverage Area Transition Complete PDU may include a maximum hops remaining field 1302 set by the originator of a Coverage Area Transition Complete PDU to the value of 1 (one), indicating that the PDU should not be forwarded by a one-hop neighbour.

A Coverage Area Transition Complete PDU may include a source identifier field 1303 that contains the requestor transaction identifier 1303a used by the candidate LAMP to correlate PDUs associated with a particular coverage area transition procedure. The requestor transaction identifier 1303a should be the same as the requestor transaction identifier 903a used in the source identifier field 903 of the Coverage Area Probe PDU 900.

A Coverage Area Transition Complete PDU may include a destination identifier field 1304 that contains the responder transaction identifier 1304a used by the current serving LAMP to correlate PDUs associated with a particular coverage area transition procedure. The responder transaction identifier 1304a should be the same as the responder transaction identifier 1003a used in the source identifier field 1003 of the Coverage Area Probe Response PDU 1000.

A Coverage Area Transition Complete PDU may include an optional PDU payload field 1305 that may, for example, contain updated radio resource management (RRM) information configured by the candidate LAMP for use within the cell following its assumption of the serving role. The updated RRM information may, for example, include updated SSB configuration such as the SSB time slots (indexes) to be used by the candidate LAMP.

The PDU of FIG. 13 may also include an integrity check field 706 which may be as described above with respect to FIG. 7.

### Downlink Data Transfer

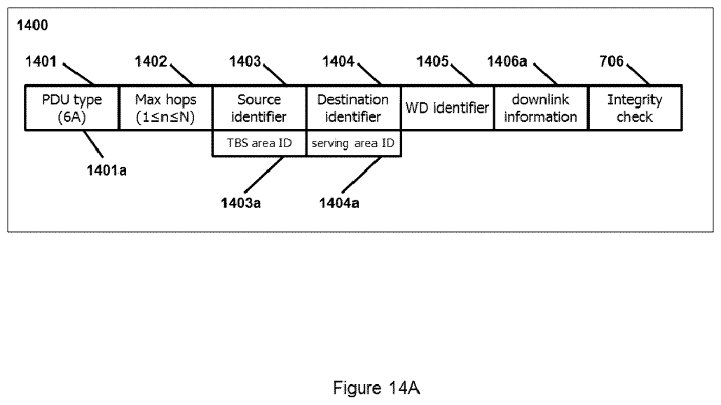

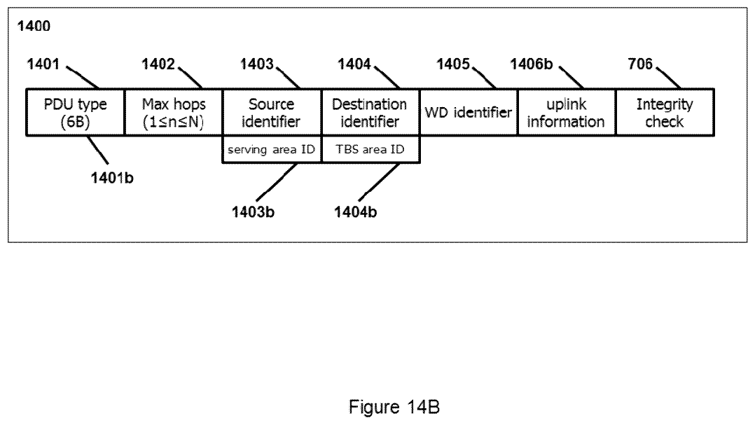

Information exchanged between a WD and TBS may be relayed through intermediate LAMPs (or other devices) using a Data Transfer PDU (FIGS. 14A and 14B).

As illustrated in FIG. 14A, a Data Transfer PDU 1400 may include a PDU type field 1401 that identifies the PDU as a Downlink Data Transfer PDU (e.g. type 6A 1401a) encapsulating downlink information destined for a target WD.

A Downlink Data Transfer PDU may include a maximum hops remaining field 1402 set by the originator of the Downlink Data Transfer PDU to a predetermined value.

A Downlink Data Transfer PDU may include a source identifier field 1403 that indicates the originator of the Downlink Data Transfer PDU. For downlink data transfer, the source identifier may be a coverage area identifier 1403a associated with the host TBS for the target WD.

A Downlink Data Transfer PDU may include a destination identifier field 1404 that indicates the destination of the Downlink Data Transfer PDU. For downlink data transfer, the destination identifier may be the coverage area identifier 1404a associated with the current location of the target WD.

A Downlink Data Transfer PDU may include PDU payload field 705 that contains an identifier associated with the target WD 1405 and downlink information 1406a to be transmitted to the target WD by the serving LAMP.

The Downlink Data Transfer PDU of FIG. 14A may also include an integrity check field 706 which may be as described above with respect to FIG. 7.

### Uplink Data Transfer

As illustrated in FIG. 14B, a Data Transfer PDU 1400 may include a PDU type field 1401 that identifies the PDU as an Uplink Data Transfer PDU (e.g. type 6B 1401b) encapsulating uplink information received from a served WD.

An Uplink Data Transfer PDU may include a maximum hops remaining field 1402 set by the originator of the Uplink Data Transfer PDU to a predetermined value.

An Uplink Data Transfer PDU may include a source identifier field 1403 that indicates the originator of the Uplink Data Transfer PDU. For uplink data transfer, the source identifier may be the coverage area identifier 1403b associated with the current location of the served WD.

An Uplink Data Transfer PDU may include a destination identifier field 1404 that indicates the destination of the Uplink Data Transfer PDU. For uplink data transfer, the destination identifier may be a coverage area identifier 1404b associated with the host TBS for the served WD.

An Uplink Data Transfer PDU may include PDU payload field 705 that contains an identifier associated with the served WD 1405 and uplink information 1406b received from the WD by the serving LAMP.

The Uplink Data Transfer PDU of FIG. 14B may also include an integrity check field 706 which may be as described above with respect to FIG. 7.

### Electronic Device

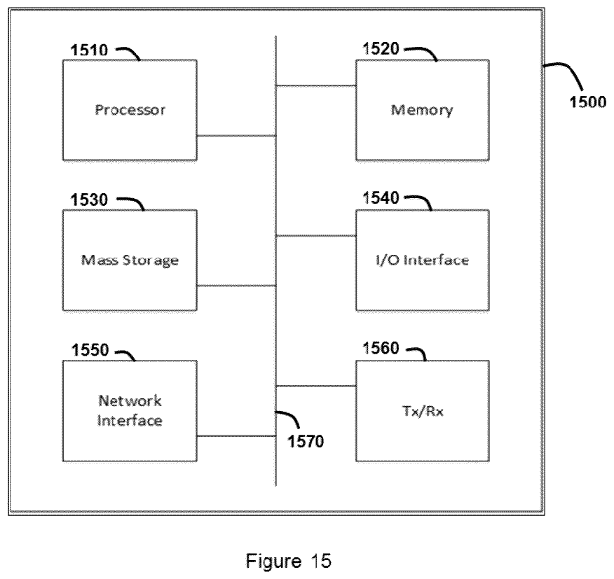

FIG. 15 illustrates a schematic diagram of an electronic device 1500 that may perform any or all of operations of the above methods and features explicitly or implicitly described herein, according to different embodiments of the present invention. For example, an electronic device such equipped with network function may be configured as a mobile radio access point, a terrestrial base station, a wireless device, or any other networking equipment or server as described herein.

As shown, the device may include a processor 1510, such as a central processing unit (CPU) or specialized processor such as a graphics processing unit (GPU) or other such processor unit, memory 1520, non-transitory mass storage 1530, input/output (I/O) interface 1540, network interface 1550, video adaptor (not shown), and one or more transceivers (Tx/Rx) 1560, all of which may be communicatively coupled via bi-directional bus 1570. The video adapter may be connected to one or more displays, and I/O interface 1540 may be connected to one or more I/O devices which may be used to implement a user interface. According to certain embodiments, any or all of the depicted elements may be utilized, or only a subset of the elements. Further, the device 1500 may contain multiple instances of certain elements, such as multiple processors, memories, network interfaces, or transceivers. Network interfaces or transceivers may be wireless communication interfaces, which are devices configured to communicate information wirelessly, for example via radio signals. Also, elements of the hardware device may be directly coupled to other elements without the bi-directional bus. Additionally, or alternatively to a processor and memory, other electronics, such as integrated circuits, may be employed for performing the required logical operations.

The memory 1520 may include any type of non-transitory memory such as static random access memory (SRAM), dynamic random access memory (DRAM), synchronous DRAM (SDRAM), read-only memory (ROM), any combination of such, or the like. The mass storage element 1530 may include any type of non-transitory storage device, such as a solid state drive, hard disk drive, a magnetic disk drive, an optical disk drive, USB drive, or any computer program product configured to store data and machine executable program code. According to certain embodiments, the memory 1520 or mass storage 1530 may have recorded thereon statements and instructions executable by the processor 1510 for performing any of the aforementioned method operations described above. The network interface 1550 may include a wired communications interface such as Ethernet™, a wireless communication interface such as Wi-Fi™ (802.11), Bluetooth™, 4G cellular, 5G cellular, and any combination of such, or the like.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be at least partially implemented as coded instructions in a computer program product. In other words, the computer program product is a computer-readable medium upon which software code is recorded to execute the method when the computer program product is loaded into memory and executed on the microprocessor of wireless communication devices.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations, or equivalents that fall within the scope of the present invention.

1. A method comprising, by a radio access point, the radio access point being mobile:
transmitting, to a set of wireless devices in a coverage area, an indication that the radio access point is providing a radio access service associated with a cell in a wireless service area, the coverage area being a sub-region of the wireless service area, the indication comprising a cell identifier corresponding to the cell in the wireless service area and a first beam identifier corresponding to a first wireless communication beam between the radio access point and the set of wireless devices in the coverage area, the first beam identifier being selected from a set of beam identifiers associated with the cell identifier;
cooperating with a second radio access point to determine that the radio access point is to relinquish to the second radio access point providing, to the set of wireless devices in the coverage area, the radio access service associated with the cell; and
in response to an indication that the second radio access point has begun providing, to the set of wireless devices in the coverage area, the radio access service associated with the cell, taking one or more actions which contribute to causing the set of wireless devices in the coverage area to perform a beam switching operation, the beam switching operation comprising the set of wireless devices ceasing to utilise the first wireless communication beam for the radio access service associated with the cell and beginning to utilise a second wireless communication beam associated with the second radio access point for the radio access service associated with the cell, the second wireless communication beam associated with a second beam identifier selected from the set of beam identifiers associated with the cell.

2. The method of claim 1, wherein said one or more actions comprise at least one of:
inhibiting transmission to the set of wireless devices in the coverage area of at least one of the cell identifier and the first beam identifier, or
reducing a strength of communication signals to the set of wireless devices by one or a combination of: motion of the radio access point away from the coverage area; directing of the first wireless communication beam away from the coverage area; and decreasing of a transmission power associated with the first wireless communication beam.

3. The method of claim 1, wherein the coverage area is associated with a coverage area identifier, the method further comprising the radio access point, while providing the radio access service to the set of wireless devices in the coverage area:
receiving a downlink information in a protocol data unit associated with the coverage area identifier;
extracting the downlink information from the protocol data unit; and
transmitting the downlink information via the first wireless communication beam associated with the coverage area.

4. The method of claim 1, wherein the coverage area is associated with a coverage area identifier, the method further comprising the radio access point, while providing the radio access service to the set of wireless devices in the coverage area:
receiving, via the first wireless communication beam associated with the coverage area, an uplink information from a wireless device in the set of wireless devices;
encapsulating the uplink information in a protocol data unit associated with the coverage area identifier; and
transmitting the uplink information in the protocol data unit associated with the coverage area identifier.

5. The method of claim 1, wherein said cooperating with the second radio access point further comprises the radio access point:
receiving a first message from the second radio access point, the first message indicating that the second radio access point is able to provide the radio access service to the coverage area; and
transmitting, to the second radio access point, a second message indicative that the radio access point will relinquish providing of the radio access service to the coverage area.

6. The method of claim 5, wherein the second message is further indicative of at least one of:
the cell identifier;
the set of beam identifiers associated with the cell identifier;
the set of wireless devices in the coverage area; and,
a radio resource configuration associated with each wireless device in the set of wireless devices in a coverage area.

7. The method of claim 1, wherein the indication that the second radio access point has begun providing, to the set of wireless devices in the coverage area, the radio access service associated with the cell, indicates that the second radio access point is transmitting, to the set of wireless devices in the coverage area, the cell identifier and the second beam identifier.

8. The method of claim 7, wherein the indication that the second radio access point has begun providing, to the set of wireless devices in the coverage area, the radio access service associated with the cell, further comprises a message from the second radio access point, the message indicative that the second mobile radio access point is transmitting the cell identifier and the second beam identifier to the set of wireless devices in the coverage area.

9. A method comprising, by a radio access point, the radio access point being mobile:
determining that the radio access point is to assume, from a second radio access point, providing of a radio access service to a set of wireless devices in a coverage area, the coverage area being a sub-region of a wireless service area, the radio access service being associated with a cell identifier corresponding to a cell in the wireless service area and provided by the second radio access point via a first wireless communication beam, the first wireless communication beam associated with the cell in the wireless service area and a first beam identifier selected from a set of beam identifiers associated with the cell identifier;
transmitting, to the set of wireless devices in the coverage area, an indication that the radio access point is providing the radio access service associated with the cell, the indication comprising the cell identifier associated with the cell and a second beam identifier corresponding to a second wireless communication beam between the radio access point and the set of wireless devices in the coverage area, the second wireless communication beam associated with the cell in the wireless service area and a second beam identifier, the second beam identifier being selected from the set of beam identifiers associated with the cell identifier and different from the first beam identifier; and
indicating, to the second radio access point, that the radio access point has begun providing the radio access service associated with the cell to the set of wireless devices in the coverage area;
wherein, subsequently to said indicating to the second radio access point, the set of wireless devices in the coverage area, performing a beam switching operation comprising the set of wireless devices ceasing to utilise the first wireless communication beam for the radio access service associated with the cell and beginning to utilise the second wireless communication beam for the radio access service associated with the cell.

10. The method of claim 9, wherein the coverage area is associated with a coverage area identifier, method further comprising the radio access point, while providing the radio access service to the set of wireless devices in the coverage area:
receiving a downlink information in a protocol data unit associated with the coverage area identifier;
extracting the downlink information from the protocol data unit; and
transmitting the downlink information via the second wireless communication beam.

11. The method of claim 9, wherein the coverage area is associated with a coverage area identifier, the method further comprising the radio access point, while providing the radio access service to the set of wireless devices in the coverage area:
receiving, via the second wireless communication beam, an uplink information from a wireless device in the set of wireless devices;
encapsulating the uplink information in a protocol data unit associated with the coverage area identifier; and
transmitting the uplink information in the protocol data unit associated with the coverage area identifier.

12. The method of claim 9, wherein said determining comprises the radio access point:
transmitting a first message to the second radio access point, the first message indicating that the radio access point is able to provide the radio access service to the coverage area; and
receiving, from the second radio access point, a second message indicative that the second radio access point will relinquish providing of the radio access service to the coverage area.

13. The method of claim 12, wherein the second message is further indicative of at least one of:
the cell identifier;
the set of beam identifiers associated with the cell identifier;
the set of wireless devices in the coverage area; and,
a radio resource configuration associated with each wireless device in the set of wireless devices in a coverage area.

14. The method of claim 9, wherein said indicating that the radio access point has begun providing the radio access service includes an indication that the radio access point is transmitting, to the set of wireless devices in the coverage area, the cell identifier and the second beam identifier.

15. The method of claim 14, wherein said indicating that the radio access point has begun providing the radio access service further comprises transmitting a message from the radio access point to the second radio access point, the message indicative that the radio access point is transmitting the cell identifier and the second beam identifier to the set of wireless devices in the coverage area.

16. An apparatus comprising one or more processors coupled with a memory storing instructions which, when executed by the one or more processors, cause the apparatus to:
transmit, to a set of wireless devices in a coverage area, an indication that the radio access point is providing a radio access service associated with a cell in a wireless service area, the coverage area being a sub-region of the wireless service area, the indication comprising a cell identifier corresponding to the cell in the wireless service area and a first beam identifier corresponding to a first wireless communication beam between the radio access point and the set of wireless devices in the coverage area, the first beam identifier being selected from a set of beam identifiers associated with the cell identifier;
cooperate with a second radio access point to determine that the radio access point is to relinquish to the second radio access point providing, to the set of wireless devices in the coverage area, the radio access service associated with the cell; and
in response to an indication that the second radio access point has begun providing, to the set of wireless devices in the coverage area, the radio access service associated with the cell, take one or more actions which contribute to causing the set of wireless devices in the coverage area to perform a beam switching operation, the beam switching operation comprising the set of wireless devices ceasing to utilise the first wireless communication beam for the radio access service associated with the cell and beginning to utilise a second wireless communication beam associated with the second radio access point for the radio access service associated with the cell, the second wireless communication beam associated with a second beam identifier selected from the set of beam identifiers associated with the cell.

17. An apparatus comprises one or more processors coupled with a memory storing instructions which, when executed by the one or more processors, cause the apparatus to:
determine that the radio access point is to assume, from a second radio access point, providing of a radio access service to a set of wireless devices in a coverage area, the coverage area being a sub-region of a wireless service area, the radio access service being associated with a cell identifier corresponding to a cell in the wireless service area and provided by the second radio access point via a first wireless communication beam, the first wireless communication beam associated with the cell in the wireless service area and a first beam identifier selected from a set of beam identifiers associated with the cell identifier;
transmit, to the set of wireless devices in the coverage area, an indication that the radio access point is providing the radio access service associated with the cell, the indication comprising the cell identifier associated with the cell and a second beam identifier corresponding to a second wireless communication beam between the radio access point and the set of wireless devices in the coverage area, the second wireless communication beam associated with the cell in the wireless service area and a second beam identifier, the second beam identifier being selected from the set of beam identifiers associated with the cell identifier and different from the first beam identifier; and
indicate, to the second radio access point, that the radio access point has begun providing the radio access service associated with the cell to the set of wireless devices in the coverage area;
wherein, subsequently to said indicating to the second radio access point, the set of wireless devices in the coverage area, perform a beam switching operation comprising the set of wireless devices ceasing to utilise the first wireless communication beam for the radio access service associated with the cell and beginning to utilise the second wireless communication beam for the radio access service associated with the cell.

18. A system comprising a first apparatus implementing a first radio access point and a second apparatus implementing a second radio access point,
wherein the first apparatus is configured to:
transmit, to a set of wireless devices in a coverage area, an indication that the first radio access point is providing a radio access service associated with a cell in a wireless service area, the coverage area being a sub-region of the wireless service area, the indication comprising a cell identifier corresponding to the cell in the wireless service area and a first beam identifier corresponding to a first wireless communication beam between the first radio access point and the set of wireless devices in the coverage area, the first beam identifier being selected from a set of beam identifiers associated with the cell identifier;
cooperate with the second radio access point to determine that the first radio access point is to relinquish to the second radio access point providing, to the set of wireless devices in the coverage area, the radio access service associated with the cell; and
in response to an indication that the second radio access point has begun providing, to the set of wireless devices in the coverage area, the radio access service associated with the cell, take one or more actions which contribute to causing the set of wireless devices in the coverage area to perform a beam switching operation, the beam switching operation comprising the set of wireless devices ceasing to utilise the first wireless communication beam for the radio access service associated with the cell and beginning to utilise a second wireless communication beam associated with the second radio access point for the radio access service associated with the cell, the second wireless communication beam associated with a second beam identifier selected from the set of beam identifiers associated with the cell,
wherein the second apparatus is configured to:
determine that the second radio access point is to assume, from the first radio access point, providing of a radio access service to the set of wireless devices in the coverage area, the radio access service being associated with the cell identifier corresponding to the cell in the wireless service area and provided by the first radio access point via the first wireless communication beam, the first wireless communication beam associated with the cell in the wireless service area and the first beam identifier;
transmit, to the set of wireless devices in the coverage area, an indication that the second radio access point is providing the radio access service associated with the cell, the indication comprising the cell identifier associated with the cell and a second beam identifier corresponding to a second wireless communication beam between the second radio access point and the set of wireless devices in the coverage area, the second wireless communication beam associated with the cell in the wireless service area and a second beam identifier, the second beam identifier being selected from the set of beam identifiers associated with the cell identifier and different from the first beam identifier; and
indicate, to the first radio access point, that the second radio access point has begun providing the radio access service associated with the cell to the set of wireless devices in the coverage area;
wherein, subsequently to said indicating to the first radio access point, the set of wireless devices in the coverage area, perform a beam switching operation comprising the set of wireless devices ceasing to utilise the first wireless communication beam for the radio access service associated with the cell and beginning to utilise the second wireless communication beam for the radio access service associated with the cell.

19. The system of claim 18, further comprising a plurality of radio access points including the first radio access point and the second radio access point, wherein the plurality of radio access points are cooperatively configured to operate as the cell associated with the cell identifier from a perspective of the set of wireless devices, each radio access point in the plurality of radio access points associated with at least one distinct beam identifier selected from the set of beam identifiers associated with the cell identifier.

20. The system of claim 18, further comprising:
a wireless device in the set of wireless devices configured to perform the beam switching operation, the beam switching operation comprising:
accessing the radio access service associated with the cell via the first wireless communication beam; and
upon determining that the radio access service associated with the cell cannot be adequately provided via the first wireless communication beam, accessing the radio access service associated with the cell via the second wireless communication beam.
